(19) United States
(12) Patent Application Publication
(10) Pub. No.: US 2025/0381015 A1
(43) Pub. Date: Dec. 18, 2025

(54) PREDICTING PALATAL GEOMETRY OF A PATIENT FOR PALATAL EXPANSION TREATMENT

(71) Applicant: Align Technology, Inc., San Jose, CA (US)

(72) Inventors: Yuxiang Wang, Newark, CA (US); Bastien Pesenti, San Jose, CA (US); John Y. Morton, San Jose, CA (US); Chunhua Li, Cupertino, CA (US); Jun Sato, San Jose, CA (US); Jeremy Riley, Mountain View, CA (US); Stuart Macrae Montgomery, San Jose, CA (US)

(21) Appl. No.: 19/237,582

(22) Filed: Jun. 13, 2025

Related U.S. Application Data
(60) Provisional application No. 63/660,397, filed on Jun. 14, 2024.

(51) Int. Cl. A61C 9/00

(52) U.S. Cl. CPC A61C 9/004

(57) ABSTRACT

Devices, systems, and methods for predicting palatal geometry are provided. In some embodiments, a system for predicting an anatomy of a patient's palate includes one or more processors and a memory operably coupled to the one or more processors and storing instructions that, when executed by the one or more processors, cause the system to perform operations including accessing a first digital representation including an initial geometry of soft tissue corresponding to a patient's palate, determining an initial geometry of hard tissue of the patient's palate, predicting a change in the hard tissue during a treatment, using the predicted change in the hard tissue to predict a change in the soft tissue during the treatment, and outputting a second digital representation including a predicted geometry of the patient's palate at a future treatment stage of a treatment plan, based on the predicted change in the soft tissue.

### CROSS-REFERENCE TO RELATED APPLICATION(S)

The present application claims the benefit of priority to U.S. Provisional Patent Application No. 63/660,397, filed Jun. 14, 2024, the disclosure of which is incorporated by reference herein in its entirety.

### TECHNICAL FIELD

The present technology generally relates to dental and orthodontic treatment, and in particular, to methods and systems for predicting palatal geometry.

### BACKGROUND

Dental appliances are used to treat various dental conditions, such as dental malocclusions, jaw dysfunction/misalignment, functional and/or aesthetic conditions, endodontic conditions, and others. For example, palatal expansion devices may be used to expand the roof of a patient's mouth and widen the patient's upper jaw to address conditions such as crossbite, crowding, or impacted teeth. Conventional non-removable palatal expansion devices typically use a jackscrew-type mechanism that delivers horizontal forces to the patient's molars to split the upper jaw along the mid-palatal suture. Such devices may interfere with the patient's speech and eating, may cause significant pain due to the large forces involved, and may not be aesthetically pleasing to wear. Patient-removable palatal expansion devices can address some of these concerns, but proper placement and fit of such devices may be challenging due to the complex and changing geometry of the palate during treatment. In some cases, poorly fit palatal expansion devices that contact the palate and/or other soft tissues may lead to pressure ulcers, which can cause pain, lower quality of life, and lead to other medical issues. Moreover, poorly fit palatal expansion devices that leave an excessively large gap between the device and the palate may allow debris to be trapped and/or cause patient discomfort.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1A is a perspective view of a palatal expander configured in accordance with embodiments of the present technology.

FIG. 1B is a bottom view of an upper dental arch of a patient including dental auxiliaries, in accordance with embodiments of the present technology.

FIG. 1C illustrates the palatal expander of FIG. 1A on the dental arch of FIG. 1B, in accordance with embodiments of the present technology.

FIG. 1D is a cross-sectional view of the palatal expander FIG. 1A on a tooth, in accordance with embodiments of the present technology.

FIG. 2A is a bottom view of an upper jaw of a patient undergoing palatal expansion, in accordance with embodiments of the present technology.

FIG. 2B is a front view of an upper jaw of a patient undergoing palatal expansion, in accordance with embodiments of the present technology.

FIGS. 2C and 2D illustrate representative examples of movement of a patient's teeth during palatal expansion, in accordance with embodiments of the present technology.

FIG. 3 illustrates a representative example of changes to the geometry of a patient's upper jaw that may occur during a palatal expansion treatment, in accordance with embodiments of the present technology.

FIGS. 4A and 4B illustrate a representative example of a movement of an expansion axis during palatal expansion, in accordance with embodiments of the present technology.

FIG. 5 is a block diagram providing a general overview of a workflow for palatal expansion treatment planning, in accordance with embodiments of the present technology.

FIG. 6 is a flow diagram illustrating a method for predicting palatal geometry using a machine learning model, in accordance with embodiments of the present technology.

FIG. 7A is a block diagram illustrating a representative example of a workflow for predicting palatal geometry during a palatal expansion treatment using a machine learning model, in accordance with embodiments of the present technology.

FIG. 7B is a block diagram illustrating a representative example of a workflow for training the machine learning model of FIG. 7A via supervised learning, in accordance with embodiments of the present technology.

FIG. 8 is a flow diagram illustrating a method for predicting palatal geometry using a soft tissue simulation, in accordance with embodiments of the present technology.

FIG. 9 is a flow diagram illustrating a workflow for predicting palatal geometry based on a finite element method (FEM) simulation of soft tissue, in accordance with embodiments of the present technology.

FIG. 10 is a flow diagram illustrating a workflow for predicting palatal geometry based on a FEM simulation of soft tissue, in accordance with embodiments of the present technology.

FIG. 11 is a flow diagram illustrating a method for predicting palatal geometry using a physics-based model, in accordance with embodiments of the present technology.

FIG. 12 is a schematic illustration of a prediction model including a plurality of vector objects, in accordance with embodiments of the present technology.

FIG. 13 is a schematic illustration of a prediction model including cantilevered beams, in accordance with embodiments of the present technology.

FIG. 14 is a flow diagram illustrating a method for predicting palatal geometry based on a changing expansion axis, in accordance with embodiments of the present technology.

FIG. 15 is a flow diagram illustrating a method for designing a palatal expander, in accordance with embodiments of the present technology.

FIG. 16A illustrates a representative example of a tooth repositioning appliance configured in accordance with embodiments of the present technology.

FIG. 16B illustrates a tooth repositioning system including a plurality of appliances, in accordance with embodiments of the present technology.

FIG. 16C illustrates a method of orthodontic treatment using a plurality of appliances, in accordance with embodiments of the present technology.

FIG. 17 illustrates a method for designing an orthodontic appliance, in accordance with embodiments of the present technology.

FIG. 18 illustrates a method for digitally planning an orthodontic treatment and/or design or fabrication of an appliance, in accordance with embodiments of the present technology.

FIG. 19 is a front view photograph of a patient for estimating a hinge point of the mid-palatal suture, in accordance with embodiments of the present technology.

### DETAILED DESCRIPTION

The present technology relates to devices, systems, and methods for predicting palatal geometry. In some embodiments, for example, the present technology provides a method including accessing a first digital representation comprising an initial geometry of a patient's palate, and outputting a second digital representation comprising a predicted geometry of the patient's palate at a future treatment stage of a palatal expansion treatment, such as a predicted shape of the soft tissues corresponding to the palate. In some embodiments, the predicted geometry is determined using a machine learning model (e.g., a neural network). Alternatively, or in combination, the predicted geometry can be determined using mathematical models (e.g., physic-based models such as finite element method (FEM) models) and/or phenomenological models (e.g., empirical-based approaches). The method can also include determining a geometry of a palatal expander configured to implement the future treatment stage, based on the predicted geometry of the palate. For example, the palatal expander can be designed to maintain an appropriate clearance gap with the palate to reduce the likelihood debris becoming trapped while also avoiding direct contact to prevent pressure ulcers. The method can further include generating instructions for fabricating the palatal expander with the determined geometry using an additive manufacturing technique.

The present technology can provide various advantages compared to conventional devices and methods for palatal expansion. For instance, conventional approaches for designing palatal expansion treatments and palatal expanders may fail to account for changes in the palatal geometry that may occur during palatal expansion treatment, such as changes in the shape of soft tissues and/or shifting of the expansion axis over time. Palatal expanders that are designed without considering such changes may fit poorly, e.g., the expander may come into direct contact with the palate and/or other sensitive soft tissues, or may leave an excessive gap with the palate allowing food and/or other debris to become trapped. Moreover, the therapeutic efficacy of the palatal expander may be compromised, e.g., if the changes of the palatal geometry cause the palatal expander to apply insufficient and/or incorrect forces. The methods and systems disclosed herein can overcome these and other challenges by predicting how palatal geometry may change over time, allowing for informed and preemptive adjustments to palatal expansion treatment and palatal expander design. Further, the provided patient-specific customization of palatal expanders can improve patient comfort, satisfaction, and safety.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

Although some embodiments of the present technology are described herein in connection with palatal expanders, this is not intended to be limiting, and the same techniques and systems can be applied to other types of dental appliances (e.g., aligners, retainers, mouthguards).

The headings provided herein are for convenience only and do not interpret the scope or meaning of the claimed present technology. Embodiments under any one heading may be used in conjunction with embodiments under any other heading.

### I. Methods and Systems for Predicting Palatal Geometry and Associated Devices

The present technology provides methods and systems for predicting changes in the geometry of a patient's palate during palatal expansion treatment. In some embodiments, a patient's palate is expanded using a series of removable dental appliances. The removable dental appliances can be sequentially applied to the patient's teeth to incrementally adjust a geometry (e.g., width) of the palate. For instance, the removable dental appliances can include a series of palatal expanders configured to adjust the palate from an initial geometry (e.g., an initial width) to a target geometry (e.g., a target width) according to a plurality of treatment stages of a treatment plan. Predicting the changes in the patient's palatal geometry can include predicting changes to the morphology and/or locations of the hard tissues (e.g., hard palate) and/or soft tissues (e.g., soft palate) of the palate at any of the treatment stages of the treatment plan. In some embodiments, predicting the changes in the patient's palatal geometry includes modeling the desired and/or expected outcomes of some or all of the treatment stages of the treatment plan.

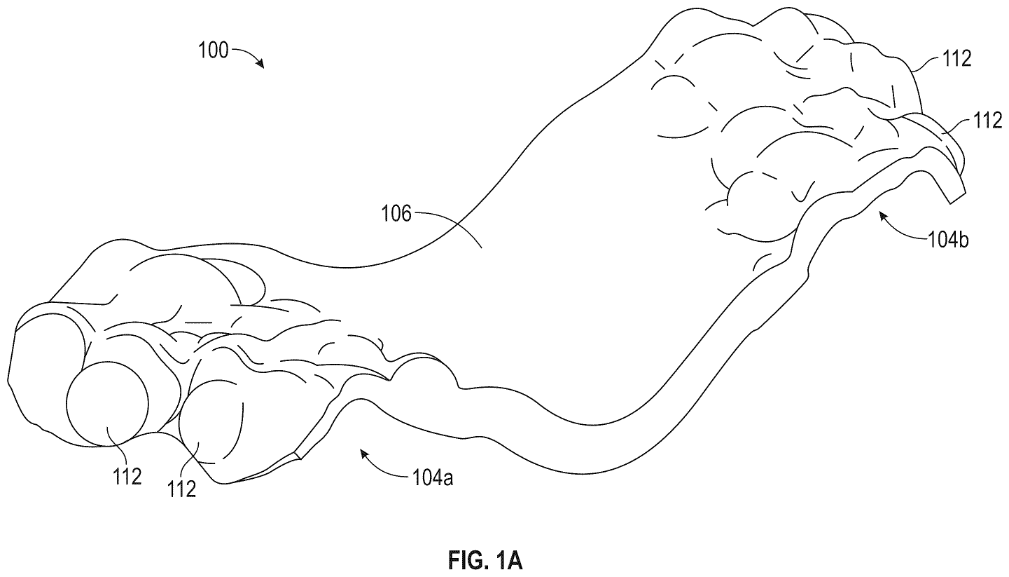

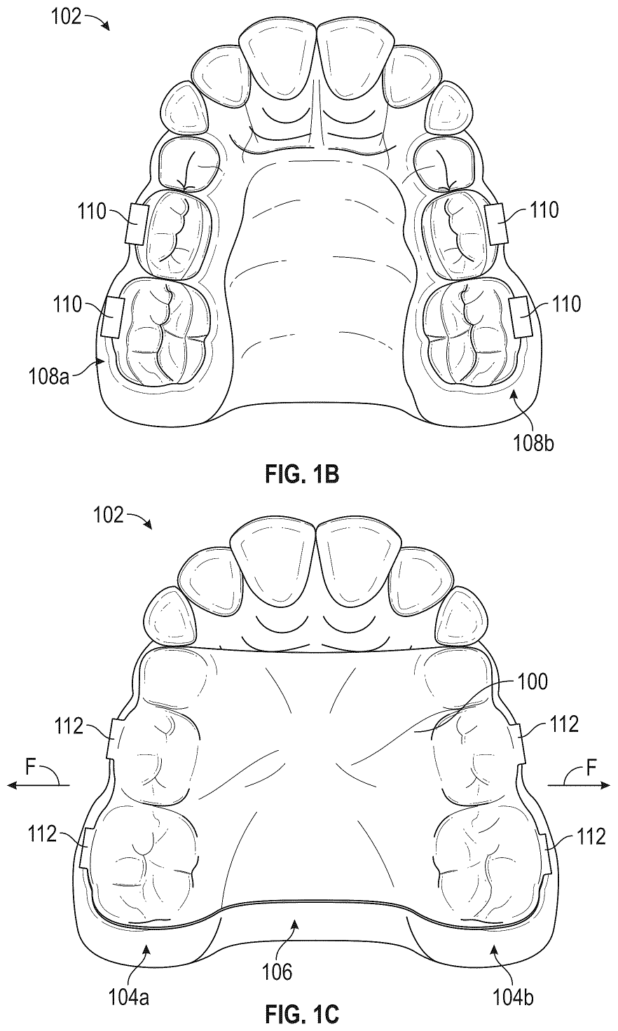

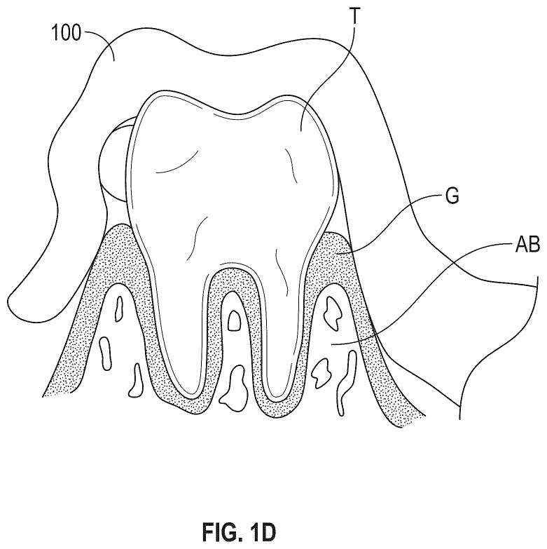

FIGS. 1A-1D illustrate a dental system for expanding a patient's palate, in accordance with embodiments of the present technology. Specifically, FIG. 1A is a perspective view of a palatal expander 100, FIG. 1B is a bottom view of an upper dental arch 102 of a patient, and FIG. 1C illustrates the palatal expander 100 on the dental arch 102, and FIG. 1D is a cross-sectional view of the palatal expander 100 on a tooth. The palatal expander 100 can be a polymeric dental appliance including a first tooth engagement portion 104a, a second tooth engagement portion 104b, and a palatal portion 106 between the first tooth engagement portion 104a and the second tooth engagement portion 104b. As best seen in FIGS. 1B and 1C, the first tooth engagement portion 104a is configured to receive one or more first teeth 108a at a first side of the dental arch 102, and the second tooth engagement portion 104b is configured to receive one or more second teeth 108b at a second, opposite side of the dental arch 102. The first teeth 108a and the second teeth 108b received by the first tooth engagement portion 104a and the second tooth engagement portion 104b, respectively, can include some or all of the posterior teeth, such as one or more molars and/or premolars. For example, the first teeth 108a and the second teeth 108b can be the three distalmost teeth on each side of the dental arch 102.

In the illustrated embodiment, the first tooth engagement portion 104a and the second tooth engagement portion 104b each include a set of cavities formed therein to receive the first teeth 108a and the second teeth 108b, respectively. An individual cavity may receive a tooth by, for example, receiving and/or extending over only a portion of the tooth, such as the crown of the tooth, a portion of the tooth proximate to the crown, a buccal surface of the tooth, a lingual surface of the tooth, etc. The interior surfaces of the cavity can conform to the occlusal, lingual, and/or buccal surfaces of the received tooth.

The palatal portion 106 is positioned between the first tooth engagement portion 104a and the second tooth engagement portion 104b to couple these components to each other. When the palatal expander 100 is worn on the dental arch 102, the palatal portion 106 can be positioned proximate to the palate of the patient (e.g., spaced apart from some or all of the palatal surface, or in direct contact with some or all of the palatal surface). The palatal portion 106 can be configured to apply forces to the first tooth engagement portion 104a and the second tooth engagement portion 104b that are transmitted to the first teeth 108a and the second teeth 108b, respectively, to cause expansion of the patient's palate. In some embodiments, the width of the palatal portion 106 is greater than the width of the dental arch 102 when the palatal expander 100 is worn on the patient's teeth, and the stiffness of the palatal portion 106 (e.g., which may vary according to the thickness and material properties of the palatal portion 106) is sufficiently high to generate and maintain a sufficient amount of force to cause expansion of the palate. The forces produced by the palatal portion 106 can be generally directed in a horizontal, outward (buccal) direction, e.g., as indicated by arrows F in FIG. 1C. The magnitude of the forces for effective palatal expansion may be significantly greater than those typically needed for other types of dental/orthodontic treatment procedures. For instance, the forces can be at least 10 N, 20 N, 30 N, 40 N, 50 N, or 60 N; and/or within a range from 9 N to 20 N, 20 N to 60 N, or from 40 N to 60 N.

In some embodiments, the first tooth engagement portion 104a and/or the second tooth engagement portion 104b can additionally contact the patient's gingiva, such as the gingiva at the lingual sides of the teeth and/or at the buccal sides of the teeth. For instance, as shown in FIG. 1D, the palatal expander 100 can contact the gingiva G at the lingual side of teeth T to apply outward expansion forces against the underlying alveolar bone AB and thus facilitate palatal expansion, in addition to the forces applied via the teeth as discussed above. This additional force may be used to provide additional translational skeletal expansion of the left and right portions of the palate, and this may be especially useful in cases where the patient has experienced bone loss around the tooth roots (e.g., due to periodontal disease). In such embodiments, the forces applied to the gingiva may be maintained below a safety threshold, e.g., to avoid pressure ulcers and/or other injuries to the gingiva. Alternatively, the palatal expander 100 can be configured to contact the gingiva without applying appreciable forces thereto, such that the expansion forces are still applied primarily or entirely to the teeth.

Referring again to FIGS. 1B and 1C, in some embodiments, the palatal expander 100 is used in combination with one or more dental auxiliaries 110 that are coupled to one or more teeth of the dental arch 102 to engage the palatal expander 100, such as the first tooth engagement portion 104a and/or the second tooth engagement portion 104b. For example, the dental auxiliaries 110 can be dental attachments (e.g., prefabricated attachments or attachments formed in situ) that are bonded to the surfaces of the patient's teeth. Other types of dental auxiliaries 110 that may be used include buttons, brackets, pins, connectors, wires, etc. The engagement between the dental auxiliaries 110 and the palatal expander 100 can serve various purposes, such as facilitating retention of the palatal expander 100 on the dental arch, improving transfer of expansion forces from the palatal expander 100 to the underlying teeth, and/or counteracting undesirable tooth movements that might otherwise occur due to expansion forces (e.g., tipping).

The geometry of the dental auxiliaries 110 can be configured to produce secure engagement with the palatal expander 100, while avoiding excessively large forces during placement of the palatal expander 100 on the dental arch 102 and/or removal of the palatal expander 100 from the dental arch 102. The dental auxiliaries 110 can each independently have any suitable shape, such as a polyhedral shape (e.g., cuboidal or other prismatic shape with flattened polygonal surfaces), a rounded shape (e.g., ellipsoidal, spherical, or other shape with rounded surfaces), or suitable combinations thereof (e.g., a first surface of a dental auxiliary 110 can be rounded and a second surface of the dental auxiliary 110 can be flattened).

The number and configuration of the dental auxiliaries 110 on the dental arch 102 can be varied as desired. For example, although the illustrated embodiment shows four dental auxiliaries 110 (e.g., two dental auxiliaries 110 on the first teeth 108a and two dental auxiliaries 110 on the second teeth 108b), in other embodiments, a different number of dental auxiliaries 110 can be used, such as one, two, three, five, six, seven, eight, or more dental auxiliaries 110. In some embodiments, multiple attachments may be placed on a single tooth. For example, two or three attachments (e.g., buccal attachments) may be placed on the terminal molar (e.g., the most distal molar of the patient) for balancing loads and providing increased retention. These attachments may be smaller in size relative to other attachments to enable placement on a single tooth. Moreover, although the dental auxiliaries 110 are depicted as being placed on the two distalmost teeth on each side of the dental arch 102, the dental auxiliaries 110 can alternatively or additionally be placed on any other teeth received by the palatal expander 100, either the first side or the second side of the dental arch 102 may not include any dental auxiliaries, etc. The geometry (e.g., shape, dimensions) of each dental auxiliary 110 can independently be varied as desired, e.g., some or all of the dental auxiliaries 110 may have different shapes, or some or all of the dental auxiliaries 110 can have the same shape.

In some embodiments, the palatal expander 100 includes one or more receptacles 112 (e.g., recesses, apertures, indentations, pockets) to receive and engage the dental auxiliaries 110. For example, the first tooth engagement portion 104a can include one or more first receptacles 112 formed therein to receive one or more dental auxiliaries 110 on the first teeth 108a, and/or the second tooth engagement portion 104b can include one or more second receptacles 112 formed therein to receive one or more dental auxiliaries 110 on the second teeth 108b. Each receptacle 112 can be formed in a sidewall of a cavity for a tooth having the corresponding dental auxiliary 110, such that when the tooth is received within the cavity, the dental auxiliary 110 on the tooth is positioned partially or entirely within the receptacle 112. The interior surface of the receptacle 112 can conform partially or entirely to the exterior surface of the received dental auxiliary 110 to provide mating engagement between the receptacle 112 and the dental auxiliary 110.

The number, geometry, and locations of the receptacles 112 in the palatal expander 100 can correspond to the number, geometry, and locations of the dental auxiliaries 110 on the dental arch 102. In the illustrated embodiment, for example, the palatal expander 100 includes four receptacles 112 at the buccal surface of the first tooth engagement portion 104a and the second tooth engagement portion 104b to receive the four dental auxiliaries 110 on the buccal surfaces of first teeth 108a and the second teeth 108b, respectively. In other embodiments, however, some or all of the receptacles 112 can be configured differently depending on the configuration of the corresponding dental auxiliaries 110, e.g., the palatal expander 100 can include fewer or more receptacles 112, etc.

The palatal expander 100 can be one of a series of palatal expanders configured to incrementally expand the patient's palate from a first width toward a second width in a plurality of treatment stages. Each palatal expander in the series can be generally similar to the palatal expander 100 shown in FIGS. 1A-1D, but the design of the palatal expander can be customized to the particular treatment stage. For instance, different palatal expanders in the series can have palatal portions 106 with different geometries (e.g., widths, thicknesses) and/or different material properties, depending on the amount of expansion to be achieved during the corresponding treatment stage. Some or all of the palatal expanders in the series can be configured for use with the same dental auxiliaries 110 (e.g., some or all of the dental auxiliaries 110 can remain on the dental arch 102 across multiple treatment stages), or some or all of the palatal expanders in the series can be configured for use with different dental auxiliaries 110 (e.g., some or all of the dental auxiliaries 110 may be removed and/or replaced with other dental auxiliaries 110 for different treatment stages).

In some embodiments, a palatal retainer may be worn by a patient to maintain the patient's palate at a target width (e.g., the target width to be achieved by a palatal expansion treatment plan). The palatal retainer can be generally similar to the palatal expander 100 and can include any of the features shown in FIGS. 1A-1D, except that the forces applied by the palatal retainer are configured to maintain a current width of the palate rather than to expand the width of the palate. A palatal retainer may be worn during any stage of a palatal expansion treatment plan, such as after the patient's palate has been expanded to a target width by a series of palatal expanders. In such embodiments, the palatal retainer may have the same or similar geometry as the final palatal expander of the treatment plan.

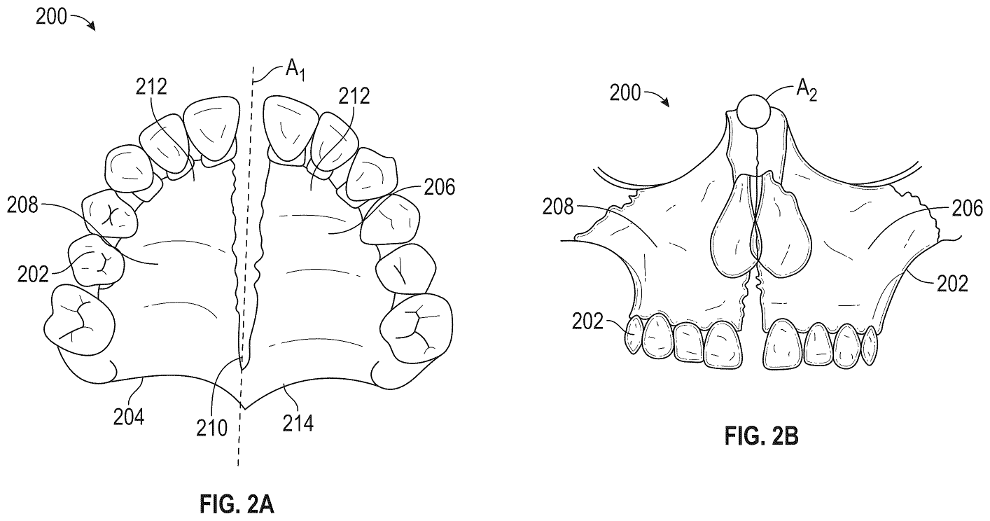

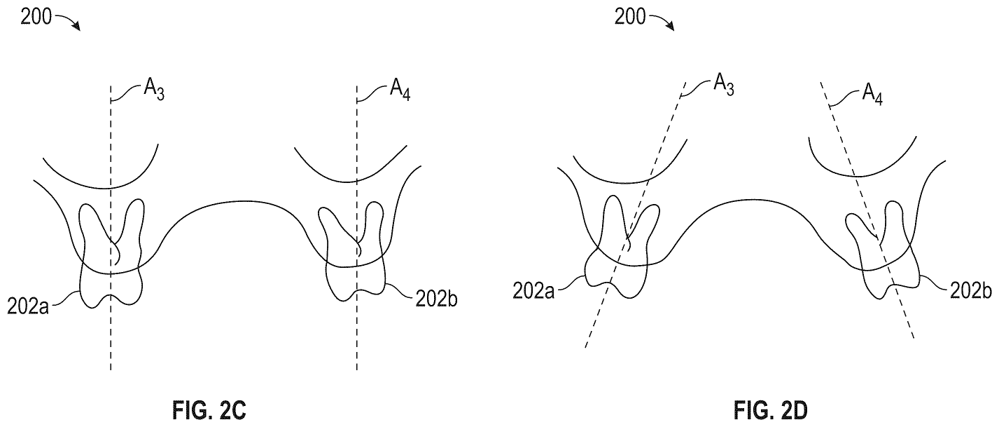

FIGS. 2A-2D illustrate changes in the geometry of a patient's palate and teeth that may occur during treatment with one or more palatal expanders, in accordance with embodiments of the present technology. Specifically, FIG. 2A is a bottom view of an upper jaw 200 of a patient undergoing palatal expansion, FIG. 2B is a front view of the upper jaw 200 of FIG. 2A, and FIGS. 2C and 2D are cross-sectional views of the upper jaw 200 illustrating an example anatomical movement of the patient's teeth.

Referring now to FIG. 2A, the upper jaw 200 can include a plurality of teeth 202 and a palate 204 including a left maxillary region 206 and a right maxillary region 208. The left maxillary region 206 and right maxillary region 208 can be divided by a mid-palatal suture 210. In some embodiments, palatal expansion treatment is configured to separate (e.g., split) the mid-palatal suture 210 to expand the width of the patient's palate 204. For instance, the mid-palatal suture 210 can be split along an anterior-posterior axis A₁ of the upper jaw 200 to cause at least a lateral separation between the left maxillary region 206 and right maxillary region 208. In some situations, the lateral separation distance may not be uniform along the axis A₁ of the upper jaw 200. For instance, an anterior portion 212 (e.g., front) of the palate 204 can expand more than a posterior portion 214 of the palate 204, resulting in a triangular separation of the mid-palatal suture 210, as depicted in FIG. 2A. Alternatively, the posterior portion 214 of the palate can expand more than the anterior portion 212 of the palate 204, resulting in an inverted triangular separation of the mid-palatal suture 210. In some situations, the expansion can occur uniformly along the axis A₁ such that at least some portions of the left maxillary region 206 and right maxillary region 208 are equidistant or substantially equidistant from the axis A₁.

In addition to the lateral separation, the palatal expansion treatment can cause rotation (e.g., tipping) of the left maxillary region 206 and/or right maxillary region 208. Turning now to FIG. 2B, in some examples, the left maxillary region 206 and right maxillary region 208 may rotate outwardly away from each other in an outward direction about an expansion axis A₂ that extends along the anterior-posterior direction away from the patient's face. The expansion axis A₂ may correspond to the center of resistance of the left maxillary region 206 and right maxillary region 208 to the expansion forces produced by the palatal expansion treatment.

In some cases, palatal expansion treatment might produce some tipping of the teeth 202. Turning now to FIG. 2C, a first tooth 202a (e.g., a first molar) and a second tooth 202b (e.g., a second molar) of the teeth 202 are shown in a first (e.g., pre-treatment) tooth arrangement. The first tooth 202a can have a first central axis A₃, and the second tooth 202b can have a second central axis A₄. In some examples, in the first tooth arrangement, the first central axis A₃ is parallel to the second central axis A₄. However, due at least in part to applied forces of a palatal expansion treatment, the left maxillary region 206 and/or right maxillary region 208 can be outwardly rotated as shown in FIG. 2B, causing a corresponding tipping movement of the first tooth 202a and/or second tooth 202b. As depicted in FIG. 2D, after the rotation of the left maxillary region 206 and/or the right maxillary region 208, the first central axis A₃ and the second central axis A₄ may no longer be parallel with each another.

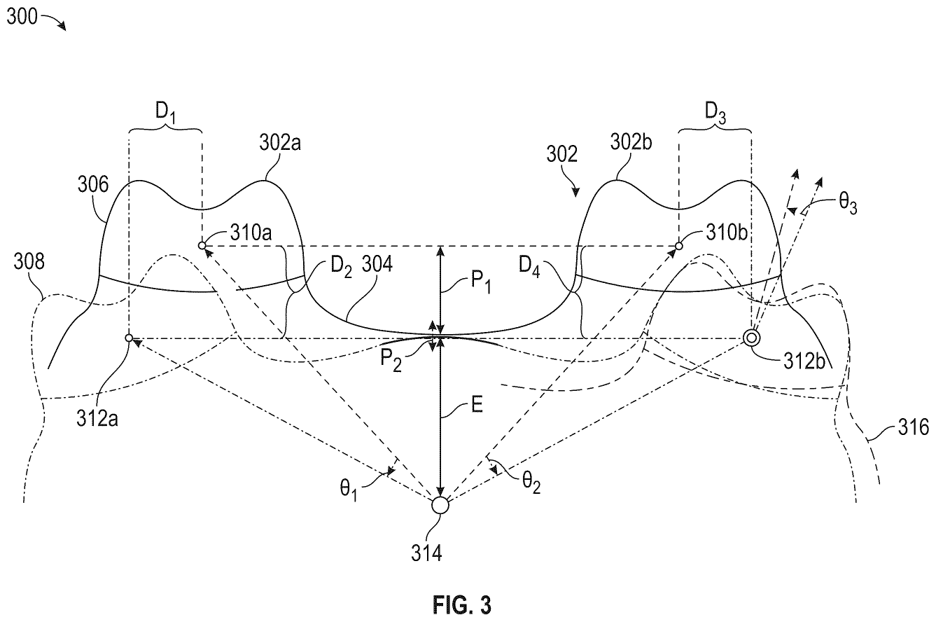

FIG. 3 illustrates a representative example of changes to the geometry of a patient's upper jaw 300 (depicted upside down) that may occur during a palatal expansion treatment, in accordance with embodiments of the present technology. One or more palatal expanders (not depicted) can be applied to the patient's teeth 302 to induce an anatomical movement configured to adjust the patient's teeth 302 and palate 304 from a first geometry 306 (e.g., a first width) to a second geometry 308 (e.g., a second width). In some examples, the anatomical movement can include a lateral displacement and/or a vertical displacement of the teeth 302. For instance, the anatomical movement can include displacing a first tooth 302a of the teeth 302 from a first position 310a (e.g., crown center) of the first geometry 306 to a second position 312a of the second geometry 308. In such cases, the first tooth 302a may be displaced laterally outward by a distance D₁ and displaced vertically upward by a distance D₂. Similarly, a second tooth 302b of the teeth 302 can be displaced from a first position 310b (e.g., crown center) of the first geometry 306 to a second position 312b of the second geometry 308. In such cases, the second tooth 302b may be displaced laterally outward by a distance D₃ and displaced vertically upward by a distance D₄. Distance D₁ can be the same, greater than, or less than distance D₃; and/or distance D₂ may be the same, greater than, or less than distance D₄. The distances D₁ and D₃ can each independently be any of the following: within a range from 1 mm to 10 mm, 1 mm to 6 mm, 1 mm to 4 mm, 4 mm to 8 mm, or 6 mm to 10 mm. The sum of the distances D₁ and D₃ can correspond to the total lateral expansion distance of the treatment.

The vertical displacement of the first tooth 302a and/or second tooth 302b and/or rotations of the right and left maxillary regions (e.g., along axes A₁ and A₂), can lead to changes in the morphology of the palate. For example, these displacements and/or rotations may result in a decrease in the heights along the palatal vault, e.g., referencing FIG. 3, from a first palatal vault height P₁ to a second palatal vault height P₂, as measured along the mid-sagittal plane. In some cases, they may also result in minor changes in shape of the palate (e.g., skews that depend on the amount of displacement or rotation that occurs on each side).

As discussed above with reference to FIGS. 2C and 2D, in some cases, palatal expansion can also result in a rotation (e.g., tipping) of the teeth 302. For instance, the first tooth 302a and/or second tooth 302b can be outwardly rotated from the first geometry 306 to the second geometry 308, as depicted. In some embodiments, the rotation of the teeth 302 can be characterized relative to an expansion axis 314. The expansion axis 314 may correspond to the center of resistance of the first tooth 302a and second tooth 302b to tipping forces produced by the palatal expansion treatment. The expansion axis 314 may be located vertically above the palate 304, e.g., by a distance E that is within a range from 10 mm to 50 mm, 20 mm to 40 mm, or 25 mm to 35 mm. In some examples, the first tooth 302a is rotated outward about the expansion axis 314 by an expansion angle θ₁, and the second tooth 302b is rotated outward about the expansion axis 314 by an expansion angle θ₂. In some examples, the expansion angle θ₂ can be equal to, less than, or greater than the expansion angle θ₁. The expansion angle θ₁ and the expansion angle θ₂ can each independently be any of the following: within a range from 0 degrees to 5 degrees, from 5 degrees to 10 degrees, from 10 degrees to 15 degrees, from 15 degrees to 20 degrees, from 20 degrees to 25 degrees, etc.

In some embodiments, excessive tipping of the teeth 302 may be undesirable. Accordingly, one or more palatal expanders of the palatal expansion treatment can be configured to apply forces to one or more of the teeth 302 to counteract the tipping, e.g., as depicted by compensation geometry 316. In some embodiments, the compensation geometry 316 represents an expected position and orientation of the second tooth 302b when forces to counteract tipping are applied to the second tooth 302b. In the compensation geometry 316, the second tooth 302b can be rotated inwardly relative to the second geometry 308 by a compensation angle θ₃ within a range from 0 degrees to 3 degrees, from 3 degrees to 6 degrees, from 6 degrees to 12 degrees, from 12 degrees to 30 degrees, etc. In some embodiments, the compensation angle θ₃ is ⅓ of the expansion angle θ₂. The compensation geometry 316 is only shown for the second tooth 302b for illustrative purposes but may alternatively or additionally be applied to the first tooth 302a in a similar manner to counteract tipping of the first tooth 302a.

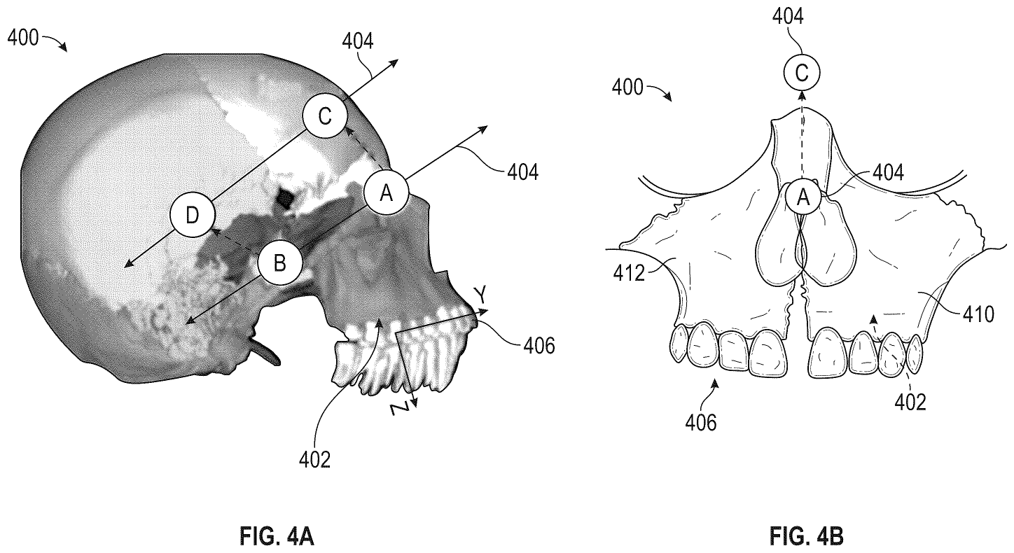

FIGS. 4A and 4B illustrate a representative example of a movement of an expansion axis during palatal expansion, in accordance with embodiments of the present technology. Referring first to FIG. 4A, which is a side view of a representative example of a patient's skull 400 during palatal expansion, anatomical movements of the palate 402 can be characterized by an expansion axis 404. The expansion axis 404 can extend along the anterior-posterior direction away from the patient's face at an angle (e.g., within a range from 5 degrees to 85 degrees, from 5 degrees to 50 degrees, from 10 degrees to 70 degrees, etc.) relative to an xy plane through the midpoint of the upper arch 406. Over the course of treatment, as the palate 402 expands, the location of the expansion axis 404 may change, e.g., the expansion axis 404 can rotate and/or translate away from its initial location. That is, the position or orientation of the expansion axis 404 may be changed as expansion occurs, and the systems and methods disclosed herein may predict for this change in location of the expansion axis 404. For instance, the expansion axis 404 can translate upward, e.g., from line AB to line CD. As can be seen in FIG. 4B, which illustrates a front view of the skull 400, the translation can appear as a vertical shift of the expansion axis 404, e.g., from point A to point C. As another example, the location of the expansion axis 404 may change by being rotated clockwise or counterclockwise as expansion occurs. In some embodiments, the changes to the geometry of the palate 402 and/or the upper arch 406 during palatal expansion can be affected by the movement of the expansion axis 404. For instance, the vertical shift in the expansion axis 404 can influence how the left maxillary region 410 and right maxillary region 412 of the palate 402 rotate outwards during palatal expansion.

In some embodiments, the present technology provides systems and methods for predicting changes to the patient's intraoral anatomy that may occur during palatal expansion therapy. Such anatomical changes may include any of the following: changes to the position and/or orientation of one or more teeth; changes to the position, orientation, and/or shape of hard tissues (e.g., bone) of the palate; changes to the position, orientation, and/or shape of the soft tissue of the palate (e.g., palatal rugae); and/or changes to the position, orientation, and/or shape of other soft tissues of the intraoral cavity (e.g., gingiva). The types and extent of the anatomical changes may vary according to patient demographics (e.g., age, gender), health conditions (e.g., periodontal issues such as bone loss), the initial positions of the teeth, the amount of palatal expansion desired, etc.

Predictions of anatomical changes can be used during the treatment planning process, for example, to inform the design of one or more palatal expanders. In some embodiments, the palatal expanders herein are designed to provide a sufficiently large clearance gap with the surface of the palate to prevent direct contact that may lead to pressure ulcers, patient discomfort, and/or other medical issues. At the same time, the clearance gap can be sufficiently small to prevent food or other debris to be trapped between the palatal expander and the palate. The palatal expanders herein can also be designed to apply sufficient forces to perform skeletal suture opening (e.g., within a range from 9 N to 20 N). The design of palatal expanders that fulfill these constraints and others may be complicated by the ongoing changes to the geometry of the palate during palatal expansion treatment, e.g., as previously described with respect to FIGS. 2A-4B. For instance, changes to the location and shape of the soft tissues may affect the amount of clearance between the palatal expander and the palate. As another example, shifting of the expansion axis may affect how forces applied by the palatal expander induce movements of the teeth and palate. As such, it may be desirable to characterize and predict anatomical changes during palatal expansion to design palatal expanders that reduce adverse effects, improve patient comfort, and/or provide effective therapy.

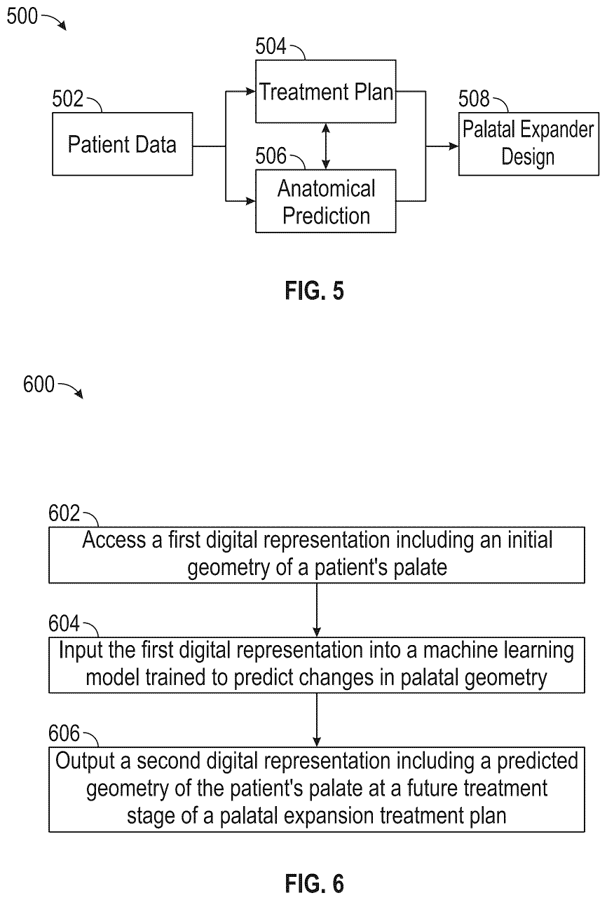

FIG. 5 is a block diagram providing a general overview of a workflow 500 for palatal expansion treatment planning, in accordance with embodiments of the present technology. The workflow 500 can be used to predict anatomical changes of a patient's palate and/or teeth. The workflow 500 can also be used to produce designs and/or fabrication instructions for one or more palatal expanders of a palatal expansion treatment. In some embodiments, some or all of the processes described with respect to the workflow 500 are implemented as computer-readable instructions (e.g., program code) that are configured to be executed by one or more processors of a computing device (e.g., a dental appliance design system). The workflow 500 can be utilized and/or combined with any of the methods described herein.

The workflow 500 can begin with accessing patient data 502 corresponding to a patient that is to receive palatal expansion treatment. The patient data 502 can be any data type that provides information on the patient's intraoral anatomy, such as photographs and/or videos (as captured on, e.g., a mobile computing device such as a smartphone, or another suitable device with a camera), scan data (e.g., intraoral and/or extraoral scans), magnetic resonance imaging (MRI) data, and/or radiographic data (e.g., standard x-ray data such as bitewing x-ray data, panoramic x-ray data, cephalometric x-ray data, computed tomography (CT) data, cone-beam computed tomography (CBCT) data, fluoroscopy data). In some embodiments, for example, the patient data 502 is or includes scan data obtained using an intraoral scanner. The scanner can include a probe (e.g., a handheld probe) for optically capturing 3D structures (e.g., by confocal focusing of an array of light beams). Examples of scanners include, but are not limited to, the iTero® intraoral digital scanner manufactured by Align Technology, Inc. In some embodiments, for example, the patient data 502 may be based on 2D images obtained using a smartphone or other device with a camera. Optionally, the patient data 502 can further include temporal information related to the data (e.g., time history of prior scan data).

In some embodiments, the patient data 502 includes pre-treatment anatomical data, such as data of the patient's anatomy before any palatal expanders have been applied to the patient's teeth in accordance with a treatment plan. Alternatively or in combination, the patient data 502 can include anatomical data obtained during an intermediate stage of a treatment plan, such as after one or more palatal expanders have already been applied to the patient's teeth for a period of time. The anatomical data may include data of one or more anatomical features that are relevant to predicting changes in palatal geometry (e.g., as discussed above with respect to FIGS. 2A-4B), such as data regarding the patient's current tooth arrangement, maxillary separation, arch width, nose position, palate shape, palate depth, and/or other palatal features of interest. The anatomical data can include position, orientation, and/or shape information of soft tissue and/or hard tissue. For instance, the anatomical data can include information regarding the patient's maxilla, mandible, incisors, canines, premolars, molars, interproximal spacings between adjacent teeth, gingiva, tongue, hard palate, soft palate, etc. Optionally, the anatomical data can include position, orientation, and/or shape information of external anatomical features, e.g., the patient's lips, nose, nasion, subnasion, cheeks, chin, jawline, eyes, eyebrows, etc. The patient data 502 can be provided in any suitable format, such as a height map, point cloud, mesh, grid (e.g., a voxel occupancy grid), triplane, image (e.g., a rendered image), etc.

Optionally, the patient data 502 can include other types of data that may be relevant to palatal expansion treatment. Examples of such data include demographic data (e.g., age, gender), medical data (e.g., current or previous disease or conditions that may affect the patient's response to palatal expansion treatment such as bone loss, periodontal disease, etc.), and patient compliance data.

The workflow 500 can include generating a treatment plan 504 for expanding the patient's palate, based on the patient data 502. In some embodiments, the treatment plan 504 is configured to adjust the patient's palate from an initial geometry (e.g., an initial width) toward a target geometry (e.g., a target width). The treatment plan can include a digital representation of the initial geometry, which can be derived from the patient data 502. For instance, the patient data 502 can include an intraoral scan of the patient's palate, and the initial geometry of the palate can be reconstructed from the intraoral scan. The treatment plan can also include a digital representation of the target geometry, which may represent the patient's palate with a desired post-treatment geometry. The treatment plan 504 can include a plurality of digital representations of intermediate geometries of the palate (e.g., intermediate widths) to incrementally adjust the palate from the initial geometry toward the target geometry, corresponding to a plurality of intermediate treatment stages of the treatment plan. Each of the intermediate treatment stages may be implemented by a respective palatal expander that applies forces to the patient's teeth to adjust the palate from the geometry specified by the preceding treatment stage toward the geometry specified by the current treatment stage, thereby incrementally expanding the patient's palate.

Optionally, one or more of the treatment stages of the treatment plan 504 can be retention stages to maintain the patient's palate at a desired geometry (e.g., the target geometry), in which case such treatment stage(s) can be implemented by a palatal retainer rather than a palatal expander. In some embodiments, the treatment stages to adjust the patient's palatal geometry occur over a first period of time (e.g., one month), and the retention stages to maintain the patient's palatal geometry occur over a second, subsequent period of time (e.g., three to six months).

The workflow 500 can also include generating an anatomical prediction 506 based on the patient data 502 and/or the treatment plan 504. The anatomical prediction 506 can include predicted changes to position, orientation, and/or shape of soft tissue and/or hard tissue of the patient's palate. In some embodiments, the anatomical prediction 506 includes a digital representation (e.g., a 2D image, 3D model, etc.) of the patient's predicted palatal geometry during palatal expansion treatment (e.g., during an intermediate treatment stage of the treatment plan 504), after palatal expansion treatment (e.g., after the final treatment stage of the treatment plan 504 and/or during a retention stage of the treatment plan 504), or both. The anatomical prediction 506 can be performed using one or more prediction methods, e.g., as discussed further herein with respect to FIGS. 6-14. In some embodiments, the anatomical prediction 506 can be used to update the treatment plan 504, or vice versa.

The anatomical prediction 506 can represent changes to the palatal geometry that are predicted to occur after the patient wears one or more palatal expanders and/or palatal retainers of the treatment plan 504. Additionally or alternatively, the anatomical prediction 506 can also represent changes to the palatal geometry that are predicted to occur if the patient does not wear one or more palatal expanders and/or palatal retainers of the treatment plan 504. For instance, if the palate may relapse if the patient fails to wear a palatal retainer at all or if the patient wears the palatal retainer for less than the prescribed duration (e.g., the patient misses wearing the palatal retainer for a week). Further, the anatomical prediction 506 can include predicting changes to the palatal geometry that are caused, at least in part, by other dental treatments, such as treatments to reposition maloccluded teeth, adjust the alignment of the upper and lower dental arches, etc.

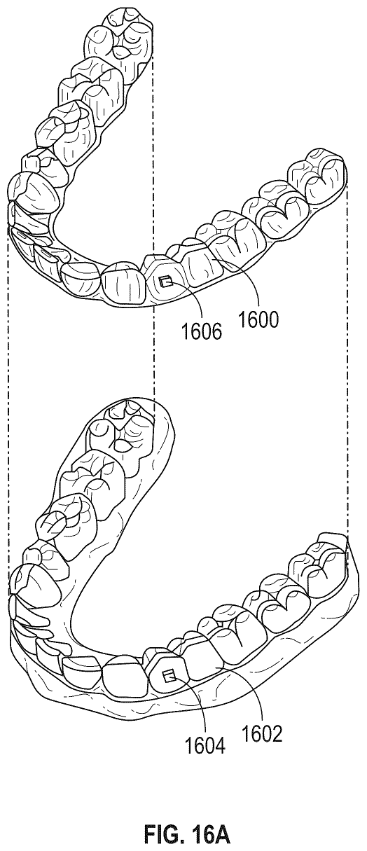

The workflow 500 can further include generating at least one palatal expander design 508 based on the treatment plan 504 and/or the anatomical prediction 506. The palatal expander design 508 can include a digital representation (e.g., a 2D image, a 3D model) of one or more palatal expanders that are configured to implement the treatment plan 504. The palatal expander design 508 can account for the treatment aims of the treatment plan 504 and/or predicted changes to palatal geometry from the anatomical prediction 506. In some embodiments, the treatment plan 504 and/or the anatomical prediction 506 provide constraints for the palatal expander design 508, e.g., the palatal expander design 508 may need to generate the appropriate forces according to the corresponding treatment stage of the treatment plan 504, while also accommodating the predicted palatal geometry specified by the anatomical prediction 506 (e.g., maintaining an appropriate clearance gap with the palate). Optionally, the palatal expander design 508 may also provide constraints for the treatment plan 504 and/or the anatomical prediction 506. The design of a palatal expander in accordance with embodiments of the present technology will be further discussed herein, such as with reference to FIG. 15.

FIG. 6 is a flow diagram illustrating a method 600 for predicting palatal geometry using a machine learning model, in accordance with embodiments of the present technology. The method 600 can be used to characterize and predict palatal geometries during a palatal expansion treatment. In some embodiments, some or all of the processes of the method 600 are implemented as computer-readable instructions (e.g., program code) that are configured to be executed by one or more processors of a computing device (e.g., a client device, a server device, or suitable combinations thereof). The method 600 can be combined with any of the methods described herein. For example, the method 600 can be performed as part of the workflow 500 of FIG. 5.

The method 600 can begin at block 602 with accessing a first digital representation including an initial geometry of a patient's palate. In some embodiments, the first digital representation includes patient data (e.g., the patient data 502 of FIG. 5). The patient data can include scan data, photographic data (e.g., photographs of the patient from multiple perspectives), video data, MRI data, and/or radiographic data (e.g., CBCT data), for example. The patient data can be provided in any suitable file format (e.g., BMP files, PNG files, STL files, STP files). In some embodiments, the patient data is collected prior to palatal expansion treatment (e.g., during a patient consultation, before any palatal expanders have been worn by the patient). However, the patient data may also be collected concurrently with palatal expansion treatment (e.g., during a treatment stage of a palatal expansion treatment, after at least one palatal expander has been worn by the patient). The patient data may be stored in a patient database, received from a client device (e.g., a computing device of a clinician), and/or retrieved from a server device. In some embodiments, the first digital representation is the patient data.

Alternatively or in combination, the first digital representation can be derived from the patient data. For instance, the method 600 can optionally include generating the first digital representation based on the patient data. The generation can include pre-processing the patient data. For instance, one or more of de-noising, cleaning, segmentation, normalization, thresholding, filtering, downsampling, equalization, or augmentation techniques may be applied to the patient data. The first digital representation may include an output of pre-processing the patient data. The generation may alternatively or additionally include performing a dimensionality reduction on the patient data. For instance, principal component analysis (PCA) can be performed on the patient data to generate principal components, and the first digital representation can include the principal components.

Further, the generation of the first digital representation may optionally include data formatting and/or conversion techniques, for instance, to condition the patient data into a suitable input format for a machine learning model. For instance, 3D data such as intraoral scan data or CBCT data may be formatted as point clouds, meshes (e.g., point clouds with connectivity), voxels, images rendered from different perspectives, or orthogonal triplanes. The data format may be selected based on the type of machine learning model to be used. For instance, data having a variable size (e.g., point clouds, mesh) may be used with a model structure that is size agnostic, such as a graph neural network (GNN) or a PointNet structure. The GNN structure propagates information along mesh edges (e.g., DiffusionNet, TreeGCN) while the PointNet structure (or PointNet++) gathers local information and then shares that information globally, usually through a global pooling operation. Data having a consistent size may be used with a model structure that uses fixed-size operators, such as a convolutional neural network (CNN) or a transformer architecture. Optionally, a transformer architecture may still be applicable for variable size data with additional pre-processing, (e.g., padding extra tokens, sampling a fixed number of points, or pooling local points together). In some embodiments, the first digital representation includes one or more of a point cloud, mesh, voxels, height map, tri-plane, perspective images, principal components (e.g., from PCA), or cross-sectional slices.

The first digital representation may also include or be associated with other patient and/or environmental data besides anatomical data that may be relevant to predicting changes in palatal geometry (e.g., soft tissue evolution), such as demographic data (e.g., age, gender), medical history data (e.g., periodontal issues such as bone loss), internal usage data (e.g., patient compliance data, strain gauge data), time scales for prediction or planned movement amount, appliance data (e.g., palatal expander stiffness), temporal information (e.g., whether the prediction is made for the beginning, middle, or end of treatment, since movement may be nonlinear over the course of treatment), etc. In some embodiments, the other patient data and/or environmental data is incorporated into the first digital representation. For instance, the other patient data and/or environmental data may be concatenated as additional features to every point/pixel/voxel in the first digital representation. As another example, an embedding vector can be created to represent the other patient data and/or environmental data. The embedding vector can be added to individual points/pixels/voxels as above. Alternatively, the first digital representation can be converted into a similar latent representation and concatenated to the embedding vector in the latent space prior to decoding.

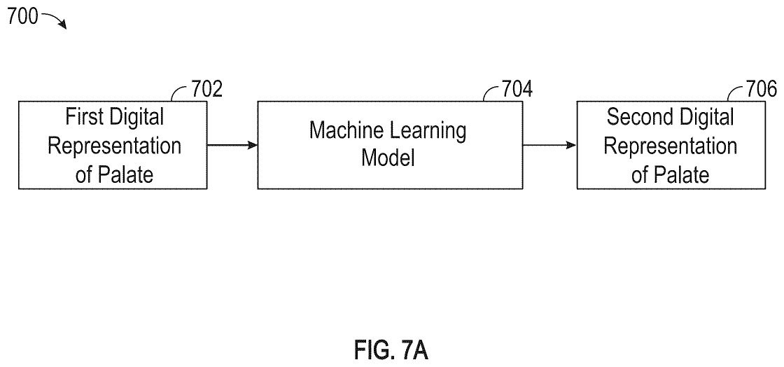

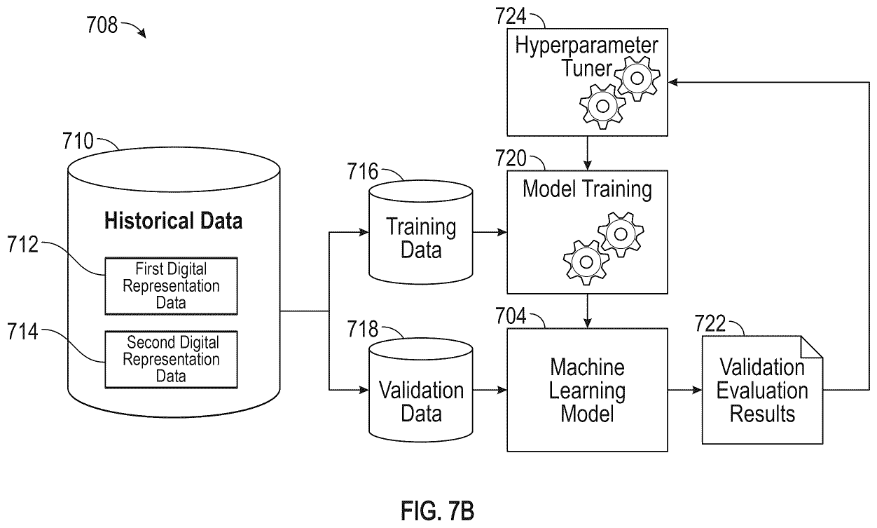

The method 600 can continue at block 604 with inputting the first digital representation into a machine learning model trained to predict changes in palatal geometry. In some embodiments, the machine learning model utilizes at least one machine learning algorithm, such as any of the following: a regression algorithm (e.g., ordinary least squares regression, linear regression, logistic regression, stepwise regression, multivariate adaptive regression splines, locally estimated scatterplot smoothing), an instance-based algorithm (e.g., k-nearest neighbor, learning vector quantization, self-organizing map, locally weighted learning), regularization algorithms (e.g., ridge regression, least absolute shrinkage and selection operator, elastic net, least-angle regression), a decision tree algorithm (e.g., Iterative Dichotomiser 3 (ID3), C4.5, C5.0, classification and regression trees, chi-squared automatic interaction detection, decision stump, M5), a Bayesian algorithm (e.g., naïve Bayes, Gaussian naïve Bayes, multinomial naïve Bayes, averaged one-dependence estimators, Bayesian belief networks, Bayesian networks, hidden Markov models, conditional random fields), a clustering algorithm (e.g., k-means, single-linkage clustering, k-medians, expectation maximization, hierarchical clustering, fuzzy clustering, density-based spatial clustering of applications with noise (DBSCAN), ordering points to identify cluster structure (OPTICS), non-negative matrix factorization (NMF), latent Dirichlet allocation (LDA), Gaussian mixture model (GMM)), an association rule learning algorithm (e.g., apriori algorithm, equivalent class transformation (Eclat) algorithm, frequent pattern (FP) growth), an artificial neural network algorithm (e.g., perceptrons, neural networks, back-propagation, Hopfield networks, autoencoders, Boltzmann machines, restricted Boltzmann machines, spiking neural nets, radial basis function networks), a deep learning algorithm (e.g., deep Boltzmann machines, deep belief networks, convolutional neural networks, stacked auto-encoders), a dimensionality reduction algorithm (e.g., PCA, independent component analysis (ICA), principle component regression (PCR), partial least squares regression (PLSR), Sammon mapping, multidimensional scaling, projection pursuit, linear discriminant analysis, mixture discriminant analysis, quadratic discriminant analysis, flexible discriminant analysis), an ensemble algorithm (e.g., boosting, bootstrapped aggregation, AdaBoost, blending, gradient boosting machines, gradient boosted regression trees, random forest), or suitable combinations thereof. Additional details and examples of machine learning models that may be used are described below, e.g., in connection with FIGS. 7A and 7B.

In some embodiments, the first digital representation is input directly into the machine learning model. Alternatively, or in combination, the first digital representation can be further processed and/or analyzed prior to inputting the first digital representation into the machine learning model. For instance, the method 600 may optionally include evaluating the quality of the first digital representation. If the first digital representation does not meet desired conditions (e.g., is blurry, has artifacts), then the first digital representation can be modified and/or replaced.

The machine learning model can be trained using data from other patients, such as pre-treatment data and post-treatment data from a plurality of patients that have undergone palatal expansion treatment (e.g., treatment with a series of palatal expanders). For each of the plurality of patients, the pre-treatment data may correspond to an initial geometry of the patient's palate, and the post-treatment data may correspond to a final geometry of the patient's palate. Based on the changes to palatal geometry (e.g., deformation, expansion) between the pre-treatment data and the post-treatment data, considered across the plurality of patients, the machine learning model can be trained to predict final palatal geometries from inputted initial palatal geometries. Alternatively or in combination, the machine learning model can be trained to predict intermediate palatal geometries (e.g., where the final palatal geometry has not yet been achieved).

The training data can include data for any suitable number of patients, such as at least 5, 10, 20, 50, 100, 500, or 1000 patients; and/or no more than 1000, 500, 100, 50, 20, 10 or 5 patients. The training data may cover patients from a broad demographic range (e.g., both pediatric and adult patients). Alternatively, or in combination, the training data can include simulated data, e.g., simulated pre-treatment, intermediary, and/or post-treatment data. The simulated data may be based on empirical data, e.g., via an interpolation of the empirical data. For instance, simulated data of intermediate palatal geometries may be generated by interpolating between data of the initial and final palatal geometries. Training can be performed using any suitable approach, such as supervised learning, unsupervised learning, or reinforcement learning. Further details on model training will be discussed below, e.g., with respect to FIGS. 7A and 7B.

At block 606, the method 600 can further include outputting a second digital representation including a predicted geometry of the patient's palate at a future treatment stage of a palatal expansion treatment plan. The second digital representation can be based on the output of the machine learning model. For instance, the machine learning model can be configured to receive the inputted first digital representation and predict palatal changes based on the first digital representation. The predicted palatal changes can then be used to construct the second digital representation. This may include converting between data formats and/or types, such as from position data and/or deformation data to a 3D digital model (e.g., a 3D mesh). The second digital representation may include a modification of the first digital representation with the predicted palatal changes. Additionally or alternatively, the second digital representation may be directly output from the machine learning model. The model output and/or the second digital representation can include a point cloud, mesh, principal components, height map, cross-sectional slices, etc. In some embodiments, the format of the second digital representation is selected based on the intended use for the prediction, e.g., perspective images may be less useful for predicting palatal expander clearance values and thus may be converted to a different format. For instance, triplane models can be sampled on each plane using bilinear interpolation. As another example, voxelized output data can be sampled via trilinear interpolation or by creating a mesh using a standard meshing algorithm. In a further example, rendered images may be converted into a mesh using another model.

In some embodiments, the second digital representation includes a predicted geometry of the patient's palate at a single future time point. In such embodiments, if the machine learning model is trained on a patient data set that consistently includes data for the initial and future time points for prediction, the model can be used to directly predict the geometry at the future time point, based on the data for the initial time point.

Alternatively, the second digital representation can include a predicted geometry of the patient's palate for each of a plurality of future time points. In such embodiments, the input to the machine learning model can include embedded temporal information that describes the amount of time between the initial time point and the desired future time points for prediction, such as the number of days, number of treatment stages, or amount of prescribed movement. The temporal information can also include the initial time point that is used as a basis for the prediction, since the changes to the palatal geometry may be nonlinear over time (e.g., the expansion rate in the first N days may not match the expansion rate in the next N days). In some embodiments, the machine learning model may be trained to directly predict the palatal geometry at multiple future time points simply by changing the embedded temporal information. As another option, the machine learning model can be trained to predict the palatal geometry at a future time point that is a fixed number of days after the initial time point, in which case the model can be applied recurrently to make multiple future predictions by using the previous prediction as input. Recurrent architectures such as long short-term memory (LSTM) can be used to improve prediction quality for a large number of recurrent predictions. Scan data and/or other patient data at previous time points may also be used to inform future predictions, e.g., by extracting local movement information using techniques such as optical flow or spatiotemporal tubelets.

Optionally, the second digital representation may be used to facilitate treatment planning and/or palatal expander design. For instance, the second digital representation can be displayed to a user (e.g., a clinician, technician, patient) to allow the user to evaluate the predicted outcome of palatal expansion treatment, produce and/or modify palatal expansion treatment plans, produce and/or modify palatal expander designs, etc. In some embodiments, the method 600 is performed by a server device which is operably coupled to one or more local client devices (e.g., one or more computing devices associated with a clinician, technician, patient, etc.). In some embodiments, the first digital representation is received from a client device, and the second digital representation is transmitted to the same client device. In some embodiments, the first digital representation is received from a client device, and the second digital representation is transmitted to a different client device.

FIG. 7A is a block diagram illustrating a representative example of a workflow 700 for predicting palatal geometry during a palatal expansion treatment using a machine learning model 704, in accordance with embodiments of the present technology. In some embodiments, some or all of the processes described with respect to the workflow 700 are implemented as computer-readable instructions (e.g., program code) that are configured to be executed by one or more processors of a computing device (e.g., a mobile phone, laptop, personal computer, workstation, remote server). The workflow 700 can be utilized and/or combined with any of the methods described herein.

The machine learning model 704 can be used in the method 600, for example, to determine a predicted geometry of a patient's palate during a palatal expansion treatment. The machine learning model 704 can be trained (FIG. 7B) to receive a first digital representation 702 of an initial geometry of a patient's palate and to output a second digital representation 706 of a predicted geometry of the patient's palate, where the predicted geometry is indicative of predicted changes to the patient's palate during palatal expansion treatment.

As shown in FIG. 7A, the workflow 700 includes receiving the first digital representation 702 of the initial geometry of the patient's palate. In some embodiments, the first digital representation 702 includes a plurality of parameters representing the anatomical shape of the patient's palate. For instance, the palate can be characterized as a height map at different points in the left-right direction and the anterior-posterior direction. As another example, PCA or similar techniques can be used to represent the palatal anatomy in a lower dimensional space. In such embodiments, statistical and/or regression-based machine learning approaches can be used to model how the palatal parameters change during palatal expansion treatment, e.g., taking into account factors such as demographic data, medical data, other patient data, environmental data, etc. Examples of machine learning models that can be used to implement statistical and/or regression-based approaches include linear regression models, multi-layer perceptrons (MLPs), convolutional neural networks (CNNs), recurrent neural networks (RNNs), and transforms.

In some embodiments, the first digital representation 702 is a non-parametric representation of the anatomical shape of the patient's palate and is directly input into a deep learning machine learning model. For example, the first digital representation 702 can be or include a point cloud, a mesh with connectivity, a voxelized occupancy grid, orthogonal triplanes, or a series of rendered images from different perspectives.

The workflow 700 can further include inputting the first digital representation 702 into the machine learning model 704. The type and architecture of the machine learning model 704 used to generate the prediction can depend on the format of the first digital representation 702. For example, pixelized representations such as rendered image, triplanes, or voxel grids can use a CNN or transformer to predict the future state of the pixelized representation. The motion of image features may also be predicted using movement-specific techniques such as optical flow. Point-based approaches may be used to predict a vector for each point that defines the displacement of that point in a future state, or in some cases may directly predict the new position of the point. Such feature vectors may be learned by propagating higher dimensional information between nodes using graph-based approaches (e.g., DiffusionNet, tree-structured graph convolution networks (TreeGCNs)) or global point feature sharing (e.g., PointNet, PointNet++), and then decoding the higher dimensional features back to a 3D digital representation. Optionally, the machine learning model 704 can use a combination of different techniques, e.g., a PointNet model can be placed before or after a CNN (e.g., an image U-net) to help improve global information sharing.

In some embodiments, the machine learning model 704 is or includes a CNN that is trained to perform the prediction. CNNs are a type of machine learning algorithm that can be used in the processing of images and/or other array-like data structures. A CNN is composed of a plurality of layers, with each layer including one or more neurons to which the operations described herein are applied. The CNN can transform input data (e.g., data received at an input layer) into output data (e.g., data output by an output layer) through a network architecture including a plurality of intermediate layers. In some embodiments, the plurality of intermediate layers include one or more convolutional layers. Each convolutional layer of a CNN can apply at least one filter (also known as a “kernel”) to input data from a preceding layer via a convolutional operation. The parameters of the kernel (e.g., kernel size, weight, biases, parameters of the kernel function(s)) can be learned from training data (e.g., using backpropagation). The CNN can optionally include multiple convolutional layers, with the input data for each convolutional layer including output data from a preceding layer (e.g., another convolutional layer or another type of layer). In some embodiments, the CNN includes one or more additional layers besides the one or more convolutional layers, such as at least one pooling layer and/or at least one fully connected layer. Further, the CNN can include any arrangement of layers forming a customized network architecture. The prediction produced by the CNN can include output data determined from a convolutional layer or any other layer of the CNN.

In embodiments where the machine learning model 704 is or includes a CNN, the first digital representation 702 can include image data in any suitable image format, including but not limited to height map images (e.g., where the value of each pixel in the image represents the height at that specific location), voxel grids, triplanes (e.g., involving the projection and aggregation of vertex data onto 3 orthogonal coordinate plates), a series of renderings from different angles, point clouds, and/or meshes. Optionally, the first digital representation 702 can include global feature data, such as patient data and/or material data, which may be added as new channels in the image data. The second digital representation 706 output by the CNN can be image data representing a transformed state of the input palate (e.g., the predicted changes in palatal geometry).

In some embodiments, the machine learning model 704 is or includes a transformer. The transformer can take various types of input data and produce various types of output data, as long as the input and output data can be converted to a “tokenized” vector representation, with each token being a vector that represents a chunk of the input or output data. The tokenization process can vary according to the type of input and output data involved.

For example, in some embodiments, the transformer can be configured to receive image data in any suitable format, including but not limited to height map images, voxel grids, triplanes, a series of renderings from different angles, point clouds, and/or meshes. In some embodiments, prior to or while being input into the transformer, the image data is split into a plurality of image patches, where each image patch is converted into a representative vector token (e.g., “patchification”). Optionally, a positional encoding can be assigned to provide spatial information for each vector token. Further, global feature data, such as patient data and/or material data, can be associated with one or more vector tokens, such as by concatenation or creating new embeddings for the global feature that are added to each vector token.

In some embodiments, the transformer can process the vector tokens using an attention mechanism, such as a scaled dot-product attention mechanism. The transformer can output new modified vector tokens that can be converted back to image data. The image data can represent a transformed state of the input palate (e.g., the second digital representation 706 representing predicted changes in palatal geometry). The transformed state may include predicted changes associated with one or more treatment stages. In some embodiments, the transformed state may represent the final state of the patient's palate following palatal expansion treatment. This may occur by sampling the new height map image (e.g., the model outputs of the transformer) at each vertex in the original input (e.g., original mesh) to get new coordinate values.

In some embodiments, the input data to the transformer is or includes mesh data. The mesh data can be converted into a tokenized form that represents the mesh data completely without duplication of mesh nodes. In some embodiments, tokenization of the mesh data may include applying blocked and patchified tokenization (BPT) to create a mesh representation suitable for tokenization. Alternatively, the mesh surface may be divided into smaller patches, tokenized, modified by the transformer on a per-patch basis, and reassembled (e.g., by stitching edge nodes back together after each patch is transformed).

In some embodiments, the input data to the transformer includes point cloud data. Tokenization of the point cloud data can be performed by grouping points based on a 3D grid structure, and each point group can be converted to a vector that represents the position of points within that cell. The output of the transformer can be converted into a mesh with connectivity data by using the original vertex connectivity, triangulation, or via transformation of the original mesh vertex positions based on the positions of the nearest vertices in the output point cloud.

Further, the transformer may be configured to receive and process other data formats including voxel occupancy grids, octrees, signed distance fields, and other 3D representations that can be converted to token representations.

In some embodiments, the machine learning model 704 is or includes a GNN. In such embodiments, the input into the GNN can include a digital graph composed of one or more nodes and/or edges. The first digital representation 702 can be converted into a digital graph. For instance, in embodiments where the first digital representation 702 is a mesh, vertices in the mesh can be represented as nodes, and connecting segments between the vertices of the mesh can be represented as edges. Alternatively or in combination, the first digital representation 702 may already have a graph data structure (e.g., the mesh includes and/or is associated with predefined nodes and/or edges). In each layer of the GNN, information can be passed between nodes along the edges connecting the nodes. The nodes may additionally or alternatively include additional geometric feature data such as local normal or curvature values to further define the direction of information flow. Further, global feature data, such as patient data, treatment stage number, material stiffness, etc., may be added to some or all of the nodes and may also influence node behavior and/or information flow.

In some embodiments, the GNN includes a plurality of message passing layers. The GNN may additionally or alternatively include global attention and/or aggregation layers. The nodal values of the final graph layer may be directly applied to the original mesh vertices to predict palatal changes. For instance, the output values could represent the vertex coordinates of the deformed shape of the input mesh, where the deformed shape could be the result of one or more stages of palatal expansion treatment.

Alternatively or in combination, the GNN can receive and process point cloud data, which may be a mesh without connectivity information (e.g., missing edges between vertices). Prior to inputting the point cloud data into the GNN, triangulation may be performed to determine and/or add edges between vertices in the point cloud data. Any suitable technique for triangulation may be used, such as Delaunay triangulation. In some embodiments, the machine learning model 704 is or includes an MLP. In such embodiments, the input into the MLP can include a single vector array. The first digital representation 702 can be converted into the single vector array. For instance, in embodiments where the first digital representation 702 is a mesh, the mesh can be converted to a single vector representation via geometric compression (e.g., principal component analysis (PCA), proper orthogonal decomposition (POD), or any other suitable order reduction approach). After compression, the mesh may be represented by a Mx1 vector, where M is the number of components to define the input space.

Alternatively or in combination, vertex data of the mesh can be used directly in PointNet or PointNet++ models. For instance, the vertex data can be arranged in a matrix (e.g., a Nx3 matrix containing the vertex data, where N is the number of vertices in the original mesh) and undergo a series of matrix transformations and MLP layers. Each MLP layer can act on each row of the vertex data independently, but at each step the rows may be transformed the same way. Optionally, additional layers and global aggregation steps can be used to promote long distance data sharing across layers of the MLP. Further, the last layer of the MLP may be modified to have a suitable shape for outputting values for each point in x, y, and z coordinates for a given node.

Alternatively or in combination, the MLP may be configured to receive a series of mesh cross-sections as input. For instance, a palatal scan may represent a 2D surface in 3D space. The intersection of the mesh with a flat plane results in a 1D curve in 2D space. This 1D curve can be input into the MLP, which may be configured to transform this curve into a new curve that represents the same cross-section in a deformed state. This can be applied for multiple cross-sections, which may be trained independently of each other. The output of the MLP may be used to directly update all the vertices along a chosen cross-section. Vertices in the mesh can then be transformed accorded to interpolated values from adjacent cross-sections (e.g., the two nearest cross-sections) to yield predicted palatal changes.

Moreover, the models described herein can be combined with one another. For instance, palatal data can be converted to a triplane representation, a PointNet model can be used to transform the points in the triplane representation, and a new triplane representation can be converted back to a 3D point cloud.

In some embodiments, the machine learning model 704 is configured to perform temporal evolution prediction. In such embodiments, the input into the machine learning model 704 can include embedded temporal information to inform the machine learning model 704 of the future time point(s) at which the prediction should be made. The machine learning model 704 can be or include a RNN that is applied at fixed time steps to generate recurrent predictions, until the desired time point is reached. Optionally, techniques such as optical flow or spatiotemporal tubelets can be used to extract local movement information from the first digital representation 702 that may further inform the prediction.

As previously noted, the second digital representation 706 may correspond to a predicted geometry of the patient's palate. The predicted geometry may correspond to a predetermined time during the course of a patient's treatment, e.g., at a time corresponding to the next treatment stage of the treatment plan or any treatment stage thereafter. In some embodiments, the second digital representation 706 includes one or more point clouds, meshes, PCA components, height maps, and/or cross-sections. Further, the second digital representation 706 may be converted from any format into a 3D mesh or other suitable format that can be used for dental appliance generation and treatment planning. In some embodiments, the second digital representation 706 includes position data that describes the position of the surface at each location in the patient's palate for a particular treatment stage, and/or includes deformation data indicative of a degree of deformation for each location in the patient's palate across treatment stages of the treatment plan.

FIG. 7B is a block diagram illustrating a representative example of a workflow 708 for training the machine learning model 704 of FIG. 7A via supervised learning, in accordance with embodiments of the present technology. In some embodiments, the machine learning model 704 can be trained using historical data 710 including first digital representation data 712 and second digital representation data 714, which may be obtained from empirical palatal expansion treatments through which palatal morphology can be learned. For example, the first digital representation data 712 can include pre-treatment data corresponding to palatal geometries of a plurality of patients prior to palatal expansion treatment, and the second digital representation data 714 can include post-treatment data corresponding to palatal geometries of the patients after palatal expansion treatment. However, the first digital representation data 712 and the second digital representation data 714 need not correspond to pre-treatment and post-treatment data, e.g., the second digital representation data 714 may correspond to a stage of palatal expansion treatment that is later than the first digital representation data 712. The historical data 710 may include data that has been collected from previous patients and/or digital representations that have been synthetically produced from other digital representations (e.g., via simulations).

The historical data 710 can be partitioned into training data 716 and validation data 718. The training data 716 can include first digital representations and second digital representations that are used in a model training process 720 to train the machine learning model 704. The model training process 720 may include learning associations between the first digital representations and the second digital representations of the training data 716. For instance, the model training process 720 may include determining the differences between the first digital representations and the second digital representations that occur over the course of palatal expansion treatment. The validation data 718 can include first digital representations and second digital representations that are not used in the model training process 720. In some embodiments, the validation data 718 can be input into the machine learning model 704, and the machine learning model 704 can generate predicted second digital representations based on the first digital representations of the validation data 718. The predicted second digital representations can be compared to the second digital representations of the validation data 718 to produce validation evaluation results 722. The validation evaluation results 722 can take any form, such as a loss (e.g., error) between the predicted second digital representations and the second digital representations of the validation data 718. Based on the loss, hyperparameters of the machine learning model 704 can be tuned via a hyperparameter tuner 724, and the machine learning model 704 can be retrained until the validation evaluation results 722 are satisfactory. In some embodiments, the validation evaluation results 722 are satisfactory when the loss is below a predetermined error tolerance. For instance, the machine learning model 704 can be configured to retrain model weights and biases (e.g., via backpropagation) until the loss is less than 20%, such as less than 5%. Once the machine learning model 704 is trained, the machine learning model 704 can be configured to predict changes to palatal geometry from patient data for a future treatment stage as described elsewhere herein. The processes described above with respect to FIG. 7B are provided as examples; any number of additional or alternative training processes are possible.

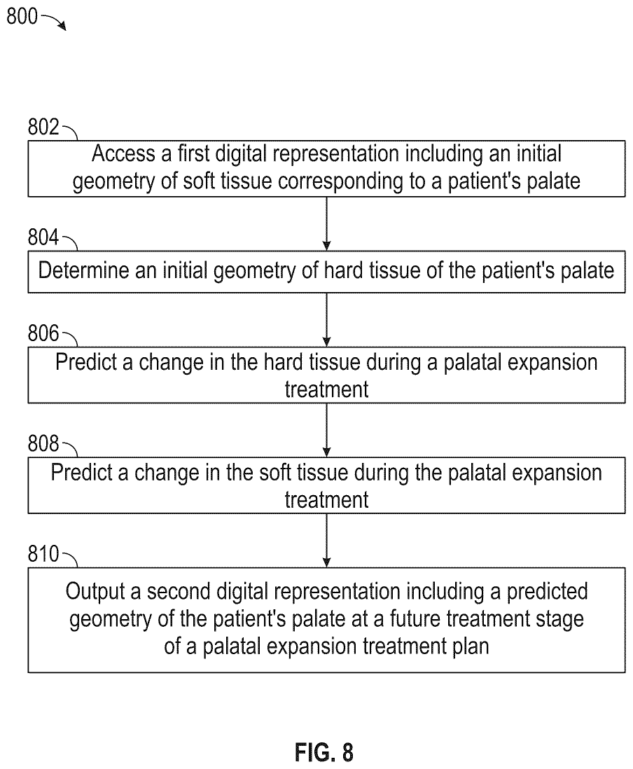

FIG. 8 is a flow diagram illustrating a method 800 for predicting palatal geometry using a soft tissue simulation, in accordance with embodiments of the present technology. The method 800 can be used to characterize and predict palatal geometries during a palatal expansion treatment. In some embodiments, some or all of the processes of the method 800 are implemented as computer-readable instructions (e.g., program code) that are configured to be executed by one or more processors of a computing device (e.g., a client device, a server device, or suitable combinations thereof). The method 800 can be combined with any of the methods described herein. For example, the method 800 can be performed as part of the workflow 500 of FIG. 5.

The method 800 can begin at block 802 with accessing a first digital representation including an initial geometry of soft tissue corresponding to a patient's palate. The first digital representation may or may not also include an initial geometry of other tissues of the patient, such as hard tissue of the patient's palate and/or facial features of the patient. In some embodiments, the first digital representation includes or is based on patient data (e.g., the patient data 502 of FIG. 5). The patient data can include scan data, photographic data (e.g., photographs of the patient from multiple perspectives), video data, MRI data, and/or radiographic data (e.g., CBCT data), for example. The patient data can be provided in any suitable file format (e.g., BMP files, PNG files, STL files, STP files). In some examples, the patient data is collected prior to palatal expansion treatment (e.g., during a patient consultation, before any palatal expanders have been worn by the patient). However, the patient data may also be collected concurrently with palatal expansion treatment (e.g., during a treatment stage of a palatal expansion treatment, after at least one palatal expander has been worn by the patient). The patient data may be stored in a patient database, received from a client device (e.g., a computing device of a clinician), and/or retrieved from a server device.

At block 804, the method 800 can continue with determining an initial geometry of hard tissue of the patient's palate. In embodiments where the first digital representation includes a digital representation of the hard tissue (e.g., CBCT data), the process of block 804 can include extracting, segmenting, or otherwise identifying the locations of the hard tissue in the first digital representation. For instance, the process of block 804 can include differentiating between hard tissue and soft issue in the first digital representation. Alternatively, in embodiments where the first digital representation does not include a digital representation of the hard tissue (e.g., scan data), the process of block 804 can include estimating the initial geometry of the hard tissue based on the first digital representation. For instance, a generic model of hard tissue (which may be resized or otherwise morphed to fit the particular patient's anatomy) can be registered to the soft tissues of the first digital representation based on anatomical landmarks in the first digital representation such as the teeth, facial features, etc.

At block 806, the method 800 can include predicting a change in the hard tissue during a palatal expansion treatment. The predicted change in the hard tissue can include changes in the position and/or orientation of the hard tissue, e.g., as discussed above with references to FIGS. 2A-4B. For example, the change can include a translation of a maxillary region, a rotation of a maxillary region about an expansion axis, and/or a change in a location of the expansion axis. In some embodiments, the change in the hard tissue is predicted by simulating motion of the hard tissue in response to palatal expansion treatment. For instance, a FEM model of the hard tissue can be generated and used to simulate the effects of palatal expansion forces on the hard tissue. In such embodiments, the hard tissue can be modeled as a rigid (e.g., mostly non-deformable or entirely non-deformable) component that rotates about an expansion axis in response to applied forces. Alternatively or in combination, the change in the hard tissue can be predicted based on the expansion distance specified by the corresponding treatment stage, without involving a simulation.

At block 808, the method 800 can continue with predicting a change in the soft tissue during the palatal expansion treatment, based on the predicted change in the hard tissue. The predicted change in the soft tissue can include changes in the position, orientation, and/or shape of the soft tissue. In some embodiments, the soft tissue is assumed to be anchored to the underlying hard tissue, such that changes in the hard tissue are expected to produce a corresponding deformation in the soft tissue (e.g., if the hard tissue moves outward, the soft tissue is expected to stretch to accommodate the outward movement). In some embodiments, the change in the soft tissue is predicted by simulating motion and/or deformation of the soft tissue in response to the change in the hard tissue. For instance, a FEM model of the soft tissue can be generated and used to simulate the effects of palatal expansion forces on the soft tissue. In such embodiments, the soft tissue can be modeled as a deformable component that deforms based on the motion of the underlying hard tissue, e.g., the hard tissue can constrain how the soft tissue moves and/or deforms. In some embodiments, the deformation may be based at least in part on historical data, e.g., historical data of soft tissue movement in previous patients may inform the types and degrees of deformation that soft tissue is likely to undergo in response to varying movements of the underlying hard tissue.

The soft tissue can be modeled with desired material properties to simulate tissue remodeling behavior (e.g., including both instantaneous and long-term remodeling), such as linear elastic properties, hyperelastic properties, and/or time-dependent properties such as viscoelastic or viscoplastic material properties (e.g., plastic flow can be used to mimic permanent changes in the soft tissue). For example, the soft tissue can be modeled as having both viscoelastic and viscoplastic material properties. The modeled tissue can have a partial deformation that recovers immediately (e.g., modeled with elasticity), recovers slowly over time (e.g., modeled with viscoelasticity), and/or that does not recover (is permanently changed).

In some embodiments, the soft tissue is modeled as being isotropic. However, in other embodiments, the soft tissue may be modeled as being anisotropic. For instance, the modeled tissue can have a different elastic modulus in the planar direction than in the transverse direction, e.g., due to the orientations of collagen fibers. Moreover, the soft tissue may be modeled as being non-homogenous. For instance, the modeled tissue may have varying material properties as a function of spatial position, e.g., the modeled tissue may be denser and/or have a higher elastic modulus near the bone, and may be sparser and/or have a lower elastic modulus further away from the bone. The material properties and/or other soft tissue parameters (e.g., tissue thickness) can be tunable parameters that are fit to data for the patient and/or based on data of other patients.

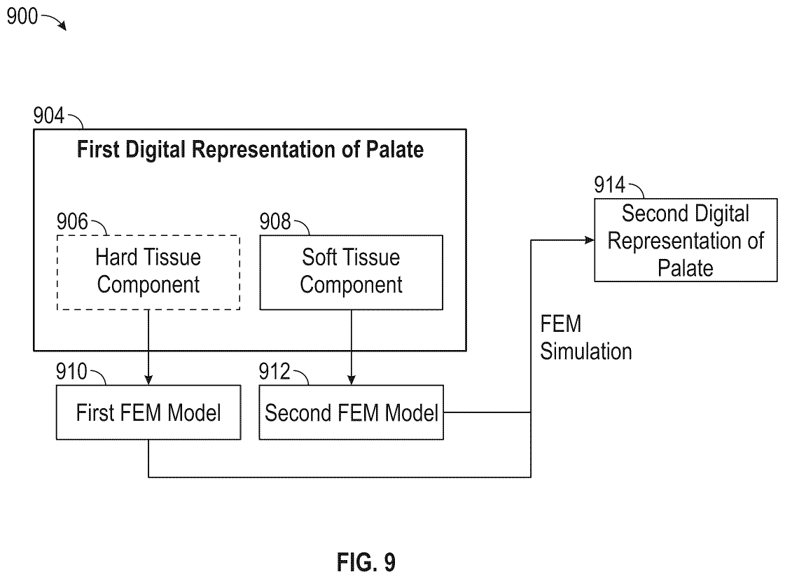

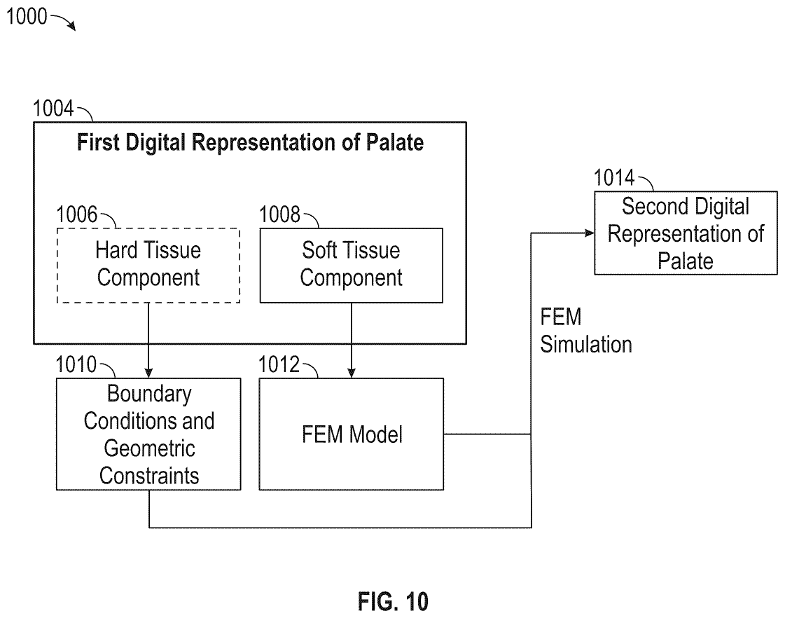

Additional examples and details of techniques for predicting changes to the soft tissue are described further below, e.g., in connection with FIGS. 9 and 10. Moreover, further details of soft tissue morphing and modeling that may be used herein are described in U.S. Pat. No. 10,993,783, the disclosure of which is incorporated by reference herein in its entirety.

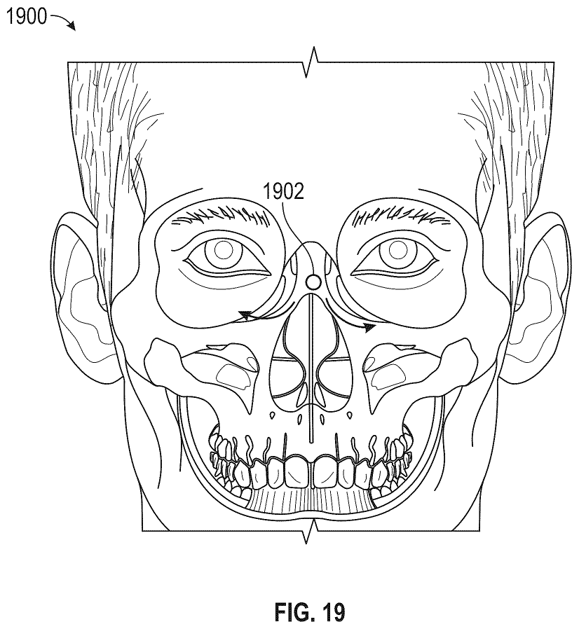

In some embodiments, the modeling techniques used to predict the changes in the hard tissue and/or soft issue are based on a location of a hinge point of the mid-palatal suture, which may correspond to the location of the expansion axis of the palate. The location of the hinge point can be determined in various ways. For example, as shown in FIG. 19, a front view photograph 1900 of the patient can be used to estimate the location of the hinge point 1902 e.g., near an intersection between a mid-sagittal line and a bridge point of the nose. Alternatively or in combination, other types of data can be used to determine the hinge point 1902, such as CBCT data or based on a generic model morphed to fit the patient anatomy. Based on the location of the hinge point 1902, a digital representation of the palate (e.g., including soft tissues, hard tissues, or both) can be digitally split into left and right regions (e.g., left and right maxillary regions), with the hinge point 1902 serving as the point of connection between the left and right regions. The split digital representation can then be used to model palatal expansion, e.g., by applying the boundary condition of anticipated arch expansion and/or tipping, and then modeling the remodeling behaviors of the soft tissue based on material properties and/or other soft tissue parameters as discussed above.

At block 810, the method 800 can further include outputting a second digital representation including a predicted geometry of the patient's palate at a future treatment stage of a palatal expansion treatment plan. The second digital representation can be based on the predicted change in the soft tissue. For instance, the second digital representation can include one or more images, point clouds, meshes, etc., representing the surface topography of the soft tissue of the palate at the future treatment stage. Optionally, the second digital representation may also include a predicted geometry of the hard tissue of the palate, e.g., based on the predicted change in the hard tissue. In some embodiments, the second digital representation includes a predicted geometry of the patient's palate at a single future time point, while in other embodiments, the second digital representation can include a predicted geometry of the patient's palate for each of a plurality of future time points.

Optionally, the second digital representation may be used to facilitate treatment planning and/or palatal expander design. For instance, the second digital representation can be displayed to a user (e.g., a clinician, technician, patient) to allow the user to evaluate the predicted outcome of palatal expansion treatment, produce and/or modify palatal expansion treatment plans, produce and/or modify palatal expander designs, etc. In some embodiments, the method 800 is performed by a server device which is operably coupled to one or more local client devices (e.g., one or more computing devices associated with a clinician, technician, patient, etc.). In some embodiments, the first digital representation is received from a client device, and the second digital representation is transmitted to the same client device. In some embodiments, the first digital representation is received from a client device, and the second digital representation is transmitted to a different client device.

FIG. 9 is a flow diagram illustrating a workflow 900 for predicting palatal geometry based on a FEM simulation of soft tissue, in accordance with embodiments of the present technology. The workflow 900 can include a first digital representation 904 of a patient's palate, which may be generated based on patient data (e.g., scan data, CBCT data) as described elsewhere herein. In some embodiments, the first digital representation 904 includes a hard tissue component 906 corresponding to hard tissue of the palate and a soft tissue component 908 corresponding to soft tissue of the palate. As indicated by the broken lines in FIG. 9, in other embodiments, the first digital representation 904 does not include the hard tissue component 906, but the hard tissue component 906 can instead be derived based on the first digital representation 904 (e.g., by aligning a generic hard tissue model to the first digital representation 904).

In the embodiment of FIG. 9, the hard tissue component 906 can be used to generate a first FEM model 910, and the soft tissue component 908 can be used to generate a second FEM model 912. The first FEM model 910 can have different properties than the second FEM model 912, e.g., the first FEM model 910 can be modeled as a rigid, non-deformable or minimally deformable component, while the second FEM model 912 can be modeled as a flexible, deformable component. In some embodiments, the first FEM model 910 and second FEM model 912 can be combined into a single FEM model that includes both rigid and deformable components, while in other embodiments the first FEM model 910 and second FEM model 912 can remain separate models.

The first FEM model 910 and second FEM model 912 can be used in an FEM simulation to generate a second digital representation 914 of a predicted geometry of the patient's palate. The FEM simulation can include, for example, simulating the effects of expansion forces on the hard tissue using the first FEM model 910, and then simulating the motion and/or deformation of the soft tissue using the second FEM model 912. The second FEM model 912 can be coupled to or otherwise constrained by the first FEM model 910, such that the simulation results with the first FEM model 910 influence the simulation for the second FEM model 912.

FIG. 10 is a flow diagram illustrating a workflow 1000 for predicting palatal geometry based on a FEM simulation of soft tissue, in accordance with embodiments of the present technology. The workflow 1000 can include a first digital representation 1004 of a patient's palate, which may be generated based on patient data (e.g., scan data, CBCT data) as described elsewhere herein. In some embodiments, the first digital representation 1004 includes a hard tissue component 1006 corresponding to hard tissue of the palate and a soft tissue component 908 corresponding to soft tissue of the palate. As indicated by the broken lines in FIG. 10, in some embodiments, the first digital representation 1004 does not include the hard tissue component 1006, but the hard tissue component 1006 can instead be derived based on the first digital representation 1004 (e.g., by aligning a generic hard tissue model to the first digital representation 1004).

In the embodiment of FIG. 10, the hard tissue component 1006 can be used to determine boundary conditions and/or geometric constraints 1010 for a FEM simulation of soft tissue. For example, it can be assumed that the soft tissue component 1008 is anchored to the hard tissue component 1006, such that the predicted motion of the hard tissue component 1006 (e.g., arch expansion and/or tipping) during palatal expansion defines and constrains the location and extent of motion and/or deformation of the soft tissue component 1008. The soft tissue component 1008 can be used to generate a FEM model 1012 that has flexible and deformable properties to simulate tissue remodeling behavior. The FEM model 1012 can be used in a FEM simulation with the boundary conditions and/or geometric constraints 1010 to generate a second digital representation 1014 of a predicted geometry of the patient's palate.

In some embodiments, the FEM-based approaches described herein (e.g., in FIGS. 8-10) may be combined with the machine learning-based approaches described herein (e.g., in FIGS. 6 and 7) to enhance predictive accuracy. For instance, machine learning models can be used to predict potential outcomes based on initial patient data, which can then be used to inform the boundary conditions and/or material properties used in the FEM simulation. This iterative process allows for a dynamic simulation environment where FEM provides the structural response of soft and/or hard tissue under given conditions, and the machine learning model adjusts those conditions based on emerging data. In some embodiments, for instance, machine learning predictions can be used to estimate the degree of tissue elasticity or resistance, which can be incorporated into the FEM simulation under various force applications to predict soft tissue deformation. Such integration allows for a holistic approach to treatment planning that adapts to the patient-specific responses observed during the treatment course.

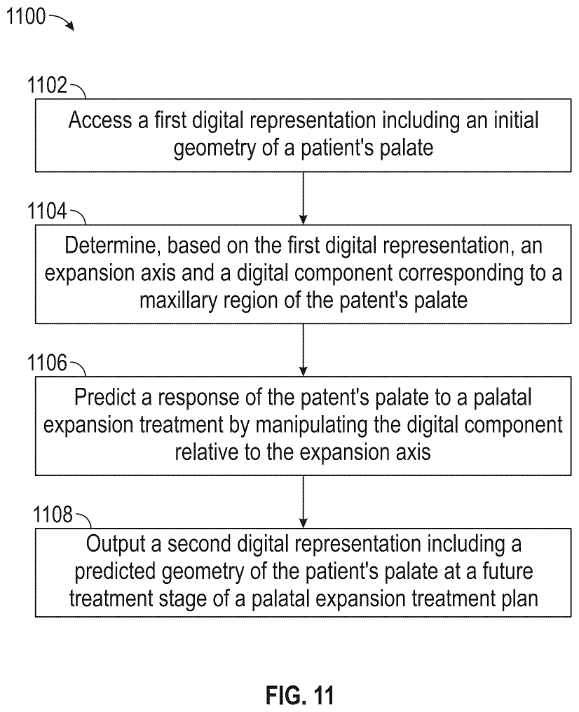

FIG. 11 is a flow diagram illustrating a method 1100 for predicting palatal geometry using a physics-based model, in accordance with embodiments of the present technology. The method 1100 can be used to characterize and predict palatal geometries during a palatal expansion treatment. In some embodiments, some or all of the processes of the method 1100 are implemented as computer-readable instructions (e.g., program code) that are configured to be executed by one or more processors of a computing device (e.g., a client device, a server device, or suitable combinations thereof). The method 1100 can be combined with any of the methods described herein. For example, the method 1100 can be performed as part of the workflow 500 of FIG. 5.

The method 1100 can begin at block 1102 with accessing a first digital representation including an initial geometry of a patient's palate. The first digital representation can include information related to the patient's palatal anatomy, such as anatomical information related to the patient's hard tissue, soft tissue, teeth, gingiva, facial features, etc. In some embodiments, the first digital representation includes or is based on patient data (e.g., the patient data 502 of FIG. 5). The patient data can include scan data, photographic data (e.g., photographs of the patient from multiple perspectives), video data, MRI data, or radiographic data (e.g., CBCT data). The patient data can be provided in any suitable file format (e.g., BMP files, PNG files, STL files, STP files). In some examples, the patient data is collected prior to palatal expansion treatment (e.g., during a patient consultation, before any palatal expanders have been worn by the patient). However, the patient data may also be collected concurrently with palatal expansion treatment (e.g., during a treatment stage of a palatal expansion treatment, after at least one palatal expander has been worn by the patient). The patient data may be stored in a patient database, received from a client device (e.g., a computing device of a clinician), and/or retrieved from a server device.

At block 1104, the method 1100 can further include determining, based on the first digital representation, an expansion axis and a digital component corresponding to a maxillary region of the patient's palate. As described herein (e.g., in connection with FIGS. 2A-4B), the expansion axis can extend along the anterior-posterior direction and can correspond to the center of resistance of the left and right maxillary regions to expansion forces. The location of the expansion axis can be determined in various ways, such as based on data of the patient's hard tissue (e.g., CBCT data), facial features (e.g., photographs), intraoral anatomy (e.g., intraoral scan data), etc. For instance, the expansion axis may be determined based on a hinge point determined from a front view photograph of the patient, e.g., as discussed above with respect to FIG. 19. In some embodiments, the location of the expansion axis is determined by identifying palatal structures in the first digital representation, and setting the location of the expansion axis relative to the palatal structures. For instance, the determination can be made by locating the patient's mid-palatal suture, and approximating a location of the expansion axis therefrom.

In some embodiments, the digital component is used to characterize and/or model changes to palatal geometry. The digital component can correspond to a specific maxillary region, e.g., a left or right maxillary region. For instance, the digital component can represent a portion of or the entirety of the volume of a maxillary region. The geometry and location of the digital component can be determined in various ways, such as based on data of the patient's hard tissue (e.g., CBCT data), facial features (e.g., photographs), intraoral anatomy (e.g., intraoral scan data), etc. In some embodiments, the geometry and location of the digital component is determined by identifying palatal structures in the first digital representation, and setting the size, shape, and location of the digital component relative to the palatal structures. For instance, a generic digital component can be overlaid onto intraoral scan data and/or photographs of the patient's face, and can be resized or otherwise morphed to fit the particular patient anatomy. As another example, CBCT data can be analyzed to extract bony structures corresponding to the maxillary region in order to generate the digital component.

Further, the digital component can be arranged at a predetermined configuration relative to the expansion axis. For instance, the digital component can have a first (e.g., upper) portion proximate to the expansion axis and a second (e.g., lower) portion spaced apart from the expansion axis. As described further below, the digital component can be configured with differing lateral deformability along a vertical direction, such that the first portion has a lower degree of lateral deformability and the second portion has a higher degree of lateral deformability, which may more accurately mimic the behavior of the palate (e.g., compared to a rigid solid body digital component).

In some embodiments, the determination of the expansion axis and/or digital component can be made automatically. For instance, the determination can be made using one or more image analysis algorithms. The algorithms can include a detection algorithm (e.g., an object or edge detection algorithm) configured to detect palatal anatomy. The algorithms can additionally or alternatively include segmentation algorithms. Alternatively, or in combination, the determination can be made manually. For instance, the expansion axis and/or digital component can be annotated by a clinician, technician, or other user.

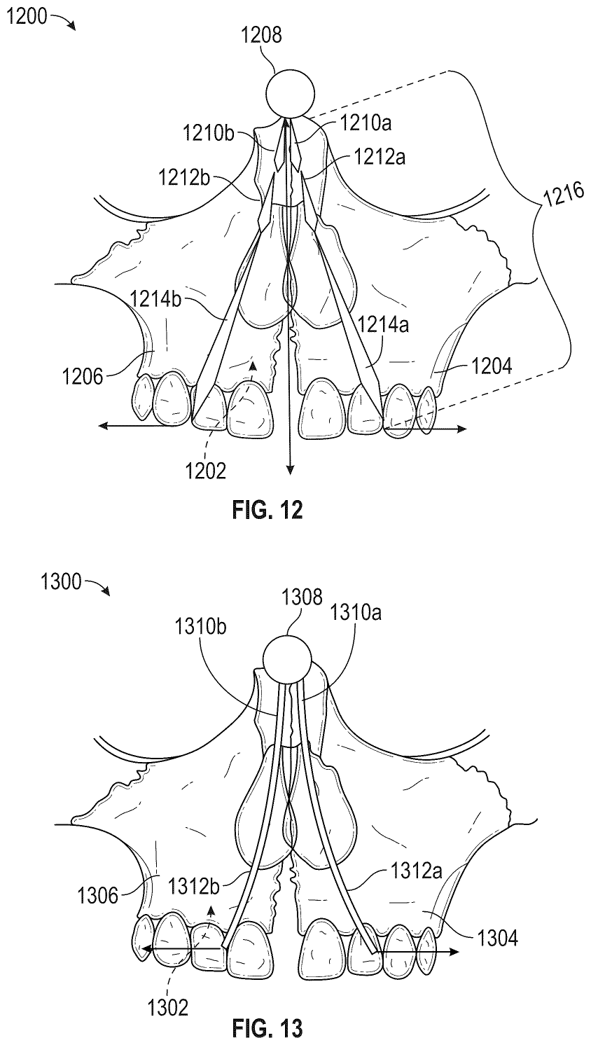

At block 1106, the method 1100 can further include predicting a response to the patient's palate to a palatal expansion treatment by manipulating the digital component relative to the expansion axis. As described herein (e.g., in connection with FIGS. 2A-4B), palatal expansion may be modeled as an outward rotation of the left and right maxillary regions about an expansion axis. Accordingly, in some embodiments, manipulating the digital component includes rotating the digital component around the expansion axis. For instance, the digital component can be rotated around the expansion axis by an angle within a range from 0 degrees to 10 degrees, 10 degrees to 20 degrees, 20 degrees to 30 degrees, 30 degrees to 40 degrees, etc. The rotation of the digital component can correspond to a predicted expansion angle of the palate, such as the expansion angles described in connection with FIG. 3. Alternatively, or in combination, manipulating the digital component can include translating a portion of the digital component along a lateral direction. For instance, the lowermost end of the digital component can be translated laterally outward to model the effect of force application to the teeth by a palatal expander. As described herein, the digital component can be a deformable component, such that the rotation and/or translation of the digital component also produces a deformation of the digital component laterally outward. Additional details and examples of deformable digital components are provided below, e.g., in connection with FIGS. 12 and 13.

The changes to the digital component (e.g., rotation, translation, and/or deformation) can be used to predict changes in the patient's palatal expansion during treatment. In some embodiments, as the digital component is rotated, translated, and/or deformed, other palatal structures (e.g., soft tissue) may be deformed and/or displaced. The predicted response can include or can be based on these deformations and/or displacements. For instance, as the digital component is modified, changes in the soft tissue can be predicted, e.g., in accordance with the techniques previously described with respect to FIGS. 8-10. The predicted change in the soft tissue may include changes in the position, orientation, and/or shape of the soft tissue. In some embodiments, the soft tissue is defined with respect to the digital component, such that changes in the digital component are expected to produce a corresponding deformation in the soft tissue (e.g., if the digital component is moved outward, the soft tissue is expected to stretch to accommodate the outward movement). In some embodiments, the change in the soft tissue is predicted by simulating motion and/or deformation of the soft tissue in response to the change of the digital component. This may be further based on the underlying hard tissue, e.g., as defined with respect to the digital component. For instance, nodes may be created to represent the connection locations (e.g., rigid couplings) between the soft tissue and the underlying hard tissue, and the deformation of the soft tissue may be predicted based on the movement of the nodes.

Optionally, the method 1100 may include determining and manipulating a plurality of digital components, such as a first digital component representing a left maxillary region and a second digital component representing a right maxillary region. Each digital component can be manipulated relative to the expansion axis to model the changes in the left and right maxillary regions, and thus, predict the response of both sides of the palate to palatal expansion treatment.

At block 1108, the method 1100 can further include outputting a second digital representation comprising a predicted geometry of the patient's palate at a future treatment stage of a palatal expansion treatment plan, based on the predicted responses. The predicted geometry may include the changes to palatal geometry (e.g., soft tissue geometry) that are the predicted results from manipulating the digital component relative to the expansion axis as discussed above. For instance, the second digital representation can include one or more images, point clouds, meshes, etc., representing the surface topography of the soft tissue of the palate at the future treatment stage. In some embodiments, the second digital representation includes a predicted geometry of the patient's palate at a single future time point, while in other embodiments, the second digital representation can include a predicted geometry of the patient's palate for each of a plurality of future time points.

Optionally, the second digital representation may be used to facilitate treatment planning and/or palatal expander design. For instance, the second digital representation can be displayed to a user (e.g., a clinician, technician, patient) to allow the user to evaluate the predicted outcome of palatal expansion treatment, produce and/or modify palatal expansion treatment plans, produce and/or modify palatal expander designs, etc. In some embodiments, the method 1100 is performed by a server device which is operably coupled to one or more local client devices (e.g., one or more computing devices associated with a clinician, technician, patient, etc.). In some embodiments, the first digital representation is received from a client device, and the second digital representation is transmitted to the same client device. In some embodiments, the first digital representation is received from a client device, and the second digital representation is transmitted to a different client device.

FIG. 12 is a schematic illustration of a prediction model 1200 including a plurality of vector objects, in accordance with embodiments of the present technology. The prediction model 1200 can be configured to implement one or more processes of the method 1100. For instance, the prediction model 1200 can be configured to predict changes to palatal geometry based on the determination and manipulation of one or more digital components.

The prediction model 1200 can represent a patient's palate 1202 including a left maxillary region 1204 and right maxillary region 1206. In some embodiments, anatomical movements of the palate 1202 can be modeled and/or characterized with respect to an expansion axis 1208, e.g., the left maxillary region 1204 and right maxillary region 1206 can rotate outwards relative to the expansion axis 1208. Over the course of treatment, as the palate 1202 expands, the expansion axis 1208 itself can rotate and/or translate, which may further affect the changes in the anatomy of the palate 1202.

As shown in FIG. 12, the prediction model 1200 can include a pair of digital components 1216 corresponding to the left maxillary region 1204 and right maxillary region 1206, respectively (the reference number is shown only for the digital component 1216 for the left maxillary region 1204 merely for purposes of simplicity). Each digital component 1216 can include a series of vector objects arranged into a kinematic chain. For instance, in the illustrated embodiment, the digital component 1216 for the left maxillary region 1204 includes a first vector object 1210a, a second vector object 1212a, and a third vector object 1214a connected to each other in an end-to-end manner; and the digital component 1216 for the right maxillary region 1206 includes a first vector object 1210b, a second vector object 1212b, and a third vector object 1214b connected to each other in an end-to-end manner. Although FIG. 12 illustrates the digital component 1216 as having three vector objects, in other embodiments, the digital component 1216 may have a different number of vector objects (e.g., two, four, five, 10, 15, 20, or more vector objects). Each vector object can be coupled to an adjacent vector object via a joint. In some embodiments, each vector object can be configured to articulate (e.g., rotate) about the joint, without decoupling from each other.

The vector objects can be arranged such that the uppermost vector object (e.g., vector objects 1210a, 1210b) is positioned proximate to the expansion axis 1208, and the remaining vector objects extend away from the expansion axis 1208 toward the patient's teeth. As shown in FIG. 12, the length of the vector objects can increase with increasing distance from the expansion axis 1208, e.g., the vector objects 1210a, 1210b are shorter than the vector objects 1212a, 1212b; which are shorter than the vector objects 1214a, 1214b. This configuration can cause the digital components 1216 to have greater lateral deformability with increasing distance from the expansion axis 1208.

The response of the patient's palate to a palatal expansion treatment can be predicted based on the position and orientation of each vector object via an inverse kinematics process (e.g., each vector object has a defined articulation and cost of movement at joints). For instance, the forces applied by a palatal expander can produce a lateral outward displacement of the free end of the lowermost vector object (e.g., vector objects 1214a, 1214b). This displacement can be propagated upward throughout the kinematic chain to affect the position and orientation of each successive vector object, with the motion of the uppermost vector object being constrained at a fixed end proximate to the expansion axis 1208. The predicted pose of the overall kinematic chain can subsequently be used to predict the palatal geometry, e.g., it can be assumed that the hard tissues of the palate will move according to the positions and orientation specified by the vector objects, and the soft tissue will deform according to the motion of the hard tissues. In some embodiments, each point in the palate is moved in a direction computed as a combination of the movement of the closest vector objects multiplied by weight values assigned to the vector objects. The vector objects may be assigned preset weights, e.g., vector objects closer to the point of interest may be assigned higher weights, while vector objects further from the point of interest may be assigned lower weights.

FIG. 13 is a schematic illustration of a prediction model 1300 including cantilevered beams, in accordance with embodiments of the present technology. The prediction model 1300 can be configured to implement one or more processes of the method 1100. For instance, the prediction model 1300 can be configured to predict changes to palatal geometry based on the determination and manipulation of one or more digital components.

The prediction model 1300 can represent a patient's palate 1302 including a left maxillary region 1304 and right maxillary region 1306. In some embodiments, anatomical movements of the palate 1302 can be modeled and/or characterized with respect to an expansion axis 1308, e.g., the left maxillary region 1304 and right maxillary region 1306 can rotate outwards relative to the expansion axis 1308. Over the course of treatment, as the palate 1302 expands, the expansion axis 1308 itself can rotate and/or translate, which may further affect the changes in the anatomy of the palate 1302.

As shown in FIG. 13, the prediction model 1300 can include a pair of digital components 1310a, 1310b (collectively, “digital components 1310”) corresponding to the left maxillary region 1204 and right maxillary region 1206, respectively. The digital components 1310 can each be an elongated deformable member, e.g., cantilevered beams 1312a, 1312b (collectively, “beams 1312”) that extend vertically downward from the expansion axis 1308 toward the teeth. Each beam 1312 can include a fixed end proximate to the expansion axis 1308 and a free end of the beam spaced apart from the expansion axis 108. This configuration can cause the digital components 1310 to have greater laterally deformability with increasing distance from the expansion axis 1308.

The response of the patient's palate to a palatal expansion treatment can be predicted based on changes to the shape of the beams 1312 in response to an applied force. For instance, the forces applied by a palatal expander can produce a lateral outward displacement of the free ends of the beams 1312. The degree of lateral displacement can decrease with decreasing distance to the fixed ends of the beams 1312. The predicted shape of the beams 1312 can subsequently be used to predict the palatal geometry, e.g., it can be assumed that the hard tissues of the palate will move according to the shapes specified by the beams 1312, and the soft tissue will deform according to the motion of the hard tissues. In some embodiments, each point in the palate is moved in a direction computed as a combination of the movement of the closest points on the beam multiplied by weight values assigned to the beam points. The beam points may be assigned preset weights, e.g., beam points closer to the point of interest may be assigned higher weights, while beam points further from the point of interest may be assigned lower weights.

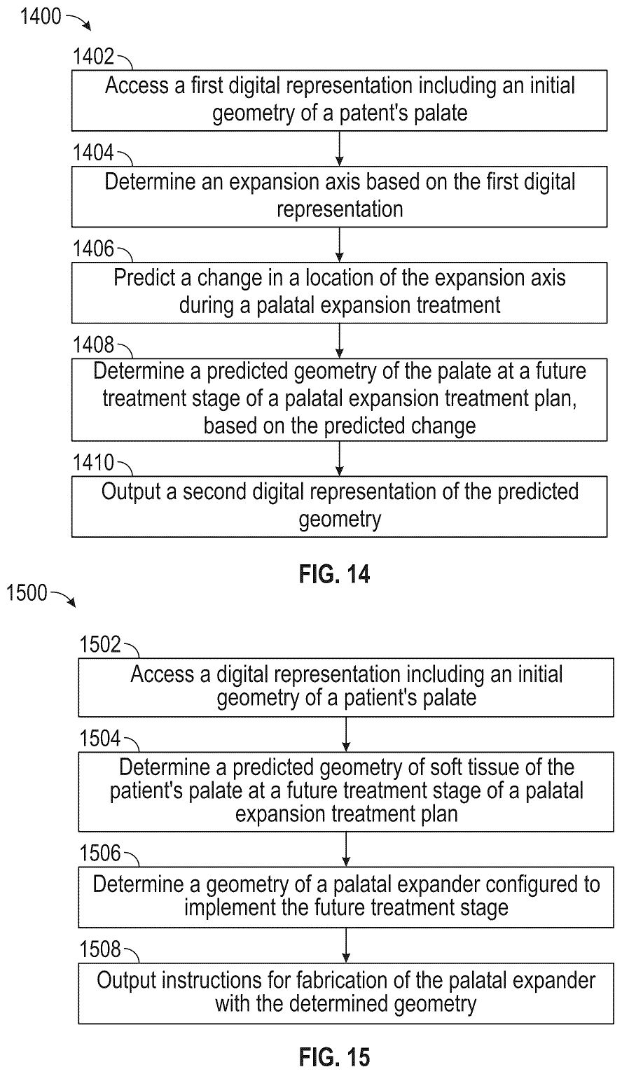

FIG. 14 is a flow diagram illustrating a method 1400 for predicting palatal geometry based on a changing expansion axis, in accordance with embodiments of the present technology. The method 1400 can be used to characterize and predict palatal geometries during a palatal expansion treatment. In some embodiments, some or all of the processes of the method 1400 are implemented as computer-readable instructions (e.g., program code) that are configured to be executed by one or more processors of a computing device (e.g., a client device, a server device, or suitable combinations thereof). The method 1400 can be combined with any of the methods described herein. For example, the method 1400 can be performed as part of the workflow 500 of FIG. 5.

The method 1400 can begin at block 1402 with accessing a first digital representation including an initial geometry of a patient's palate. The first digital representation can include information related to the patient's palatal anatomy, such as anatomical information related to the patient's hard tissue, soft tissue, teeth, gingiva, facial features, etc. In some embodiments, the first digital representation includes or is based on patient data (e.g., the patient data 502 of FIG. 5). The patient data can include scan data, photographic data (e.g., photographs of the patient from multiple perspectives), video data, MRI data, or radiographic data (e.g., CBCT data). The patient data can be provided in any suitable file format (e.g., BMP files, PNG files, STL files, STP files). In some examples, the patient data is collected prior to palatal expansion treatment (e.g., during a patient consultation, before any palatal expanders have been worn by the patient). However, the patient data may also be collected concurrently with palatal expansion treatment (e.g., during a treatment stage of a palatal expansion treatment, after at least one palatal expander has been worn by the patient). The patient data may be stored in a patient database, received from a client device (e.g., a computing device of a clinician), and/or retrieved from a server device.

At block 1404, the method 1400 can further include determining an expansion axis based on the first digital representation. As described herein (e.g., in connection with FIGS. 2A-4B), the expansion axis can extend along the anterior-posterior direction and can correspond to the center of resistance of the left and right maxillary regions to expansion forces. The location of the expansion axis can be determined in various ways, such as based on data of the patient's hard tissue (e.g., CBCT data), facial features (e.g., photographs), intraoral anatomy (e.g., intraoral scan data), etc. For instance, the expansion axis may be determined based on a hinge point determined from a front view photograph of the patient, e.g., as discussed above with respect to FIG. 19. In some embodiments, the location of the expansion axis is determined by identifying palatal structures in the first digital representation, and setting the location of the expansion axis relative to the palatal structures. For instance, the determination can be made by locating the patient's mid-palatal suture, and approximating a location of the expansion axis therefrom.

In some embodiments, the determination of the expansion axis is made automatically. For instance, the determination can be made using one or more image analysis algorithms. The algorithms can include a detection algorithm (e.g., an object or edge detection algorithm) configured to detect palatal anatomy. The algorithms can additionally or alternatively include segmentation algorithms. Alternatively, or in combination, the determination can be made manually. For instance, the expansion axis can be annotated by a clinician, technician, or other user.

At block 1406, the method 1400 can further include predicting a change in a location of the expansion axis during a palatal expansion treatment. The predicted change in location can include a vertical translation of the expansion axis (e.g., in an upward direction as shown in FIGS. 4A and 4B), a horizontal translation of the expansion axis, and/or a rotation of the expansion axis, for example. In some embodiments, the change is predicted using one or more of a machine learning model, physics-based simulation, or data from other patients that have undergone palatal expansion treatment. For instance, pre-treatment and post-treatment data of other patients can be analyzed to assess how the location of expansion axis changes over time, as well as the influence of various factors (e.g., demographics, medical conditions) on the changes to the expansion axis. Such analyses can be performed using statistical methods, machine learning models, or suitable combinations thereof. Alternatively or in combination, physics-based simulations (e.g., FEM simulations) can be used to predict how the expansion axis will change over time for a particular patient. Moreover, temporal information can be used to inform the prediction, e.g., the magnitude and type of change may vary depending on the treatment stage and may be nonlinear over time.

At block 1408, the method 1400 can further include determining a predicted geometry of the palate at a future treatment stage of a palatal expansion treatment plan, based on the predicted change. The predicted palatal geometry can include soft tissue geometry, hard tissue geometry, or suitable combinations thereof. As discussed elsewhere herein, the location of the expansion axis may affect the movements of the left and right maxillary regions, and thus the resulting geometry of the soft tissues of the palate. In some embodiments, for example, the palatal geometry is predicted using a physics-based simulation or model that accounts for the change in the location of the expansion axis, such as any of the embodiments of FIGS. 8-13. In some embodiments, the prediction process involves determining a first predicted geometry of the patient's palate for a first treatment stage of the treatment plan, based on the expansion axis being at a first location; determining a second predicted geometry of the patient's palate for a second treatment stage of the treatment plan, based on the expansion axis being at a second, different location; determining a third predicted geometry of the patient's palate for a third treatment stage of the treatment plan, based on the expansion axis being at a third, different location; and so on.

At block 1410, the method 1400 can further include outputting a second digital representation of the predicted geometry. For instance, the second digital representation can include one or more images, point clouds, meshes, etc., representing the surface topography of the soft tissue of the palate at the future treatment stage. In some embodiments, the second digital representation includes a predicted geometry of the patient's palate at a single future time point, while in other embodiments, the second digital representation can include a predicted geometry of the patient's palate for each of a plurality of future time points.

Optionally, the second digital representation may be used to facilitate treatment planning and/or palatal expander design. For instance, the second digital representation can be displayed to a user (e.g., a clinician, technician, patient) to allow the user to evaluate the predicted outcome of palatal expansion treatment, produce and/or modify palatal expansion treatment plans, produce and/or modify palatal expander designs, etc. In some embodiments, the method 1400 is performed by a server device which is operably coupled to one or more local client devices (e.g., one or more computing devices associated with a clinician, technician, patient, etc.). In some embodiments, the first digital representation is received from a client device, and the second digital representation is transmitted to the same client device. In some embodiments, the first digital representation is received from a client device, and the second digital representation is transmitted to a different client device.

The prediction models used in the embodiments of FIGS. 11-14 may be calibrated to improve prediction accuracy. Calibration can be performed using more computationally intensive method such as FEM analysis (e.g., based on CBCT data and/or other bone data). Calibration can also be performed based on statistical fitting using machine learning models or other techniques that utilize previous patient data. Calibration can also be performed based on empirical positioning and parameterization of the expansion axis and palatal structures based on typical or average human morphology, or based on parameterized morphology for the particular patient based on CBCT data and/or other patient-specific data.

FIG. 15 is a flow diagram illustrating method 1500 for designing a palatal expander, in accordance with embodiments of the present technology. The method 1500 can be used to design one or more palatal expanders configured to implement a palatal expansion treatment, such as the embodiments discussed with references to FIGS. 1A-1D. In some embodiments, some or all of the processes of the method 1500 are implemented as computer-readable instructions (e.g., program code) that are configured to be executed by one or more processors of a computing device (e.g., a client device, a server device, or suitable combinations thereof). The method 1500 can be combined with any of the methods described herein. For example, the method 1500 can be performed as part of the workflow 500 of FIG. 5.

The method 1500 can begin at block 1502 with accessing a digital representation including an initial geometry of a patient's palate 1502. The first digital representation can include information related to the patient's palatal anatomy, such as anatomical information related to the patient's hard tissue, soft tissue, teeth, gingiva, facial features, etc. In some embodiments, the first digital representation includes or is based on patient data (e.g., the patient data 502 of FIG. 5). The patient data can include scan data, photographic data (e.g., photographs of the patient from multiple perspectives), video data, MRI data, or radiographic data (e.g., CBCT data). The patient data can be provided in any suitable file format (e.g., BMP files, PNG files, STL files, STP files). In some examples, the patient data is collected prior to palatal expansion treatment (e.g., during a patient consultation, before any palatal expanders have been worn by the patient). However, the patient data may also be collected concurrently with palatal expansion treatment (e.g., during a treatment stage of a palatal expansion treatment, after at least one palatal expander has been worn by the patient). The patient data may be stored in a patient database, received from a client device (e.g., a computing device of a clinician), and/or retrieved from a server device.

At block 1504, the method 1500 can further include determining a predicted geometry of soft tissue of the patient's palate at a future treatment stage of a palatal expansion treatment plan. The determination can be made using any of the methods described herein, for example, any of the methods described with reference to FIGS. 5-14. Optionally, the method 1500 can also include determining a predicted geometry of hard tissue of the patient's palate. The future treatment stage can be an intermediate treatment stage, a final treatment stage, or a post-treatment (retention) stage. The prediction can be made for a single future treatment stage, for a plurality of future treatment stages, or even for all of the planned future treatment stages.

At block 1506, the method 1500 can further include determining a geometry of at least one palatal expander configured to implement the future treatment stage. The palatal expander can have any of the features described herein, e.g., in connection with FIGS. 1A-1D. For instance, the palatal expander can include a first tooth engagement portion configured to receive one or more first teeth of the patient, a second tooth engagement portion configured to receive one or more second teeth of the patient, and a palatal portion between the first and second tooth engagement portions. The palatal expander can be one of a series of palatal expanders configured to incrementally adjust the patient's palate from an initial geometry to a target geometry.

The palatal expander geometry can be determined based on the predicted geometry of the soft tissue of the patient's palate. In some embodiments, the predicted geometry of the soft tissue may provide constraints for the palatal expander. For instance, the palatal expander (e.g., the palatal portion) can be configured to maintain an appropriate clearance gap with the soft tissue of the palate. The clearance gap can be sufficiently large to avoid direct contact with the surface of the palate that may lead to pressure ulcers, patient discomfort, and/or other medical issues, but also sufficiently small to prevent food or other debris from becoming trapped between the palatal expander and the palate.

In some embodiments, the palatal expander geometry is configured to provide a desired degree of contact with the gingiva. As described elsewhere herein, a palatal expander may be designed to avoid contacting the gingiva, to contact and apply force to the gingiva, or to contact the gingiva without applying appreciable forces to the gingiva. In embodiments where gingival contact is desirable, soft tissue modeling can be performed to assess the effects on the activation of the palatal expander (e.g., gingival contact may reduce the magnitude of the expansion force due to absorption by the soft gingival tissue and/or may change the direction of the force). The effects may be based on the compliance of the gingiva (e.g., tissue along the alveolar bone is different from tissue along the teeth; tissue may vary between the hard and soft palate; tissue may vary based on the individual patient's anatomy and medical condition) and/or on the properties of the palatal expander (e.g., material stiffness, thickness). The modeling can also account for patient-specific differences in flexural modulus (e.g., of bone).

In some embodiments, the palatal expander geometry may be adjusted to account for patients with medical conditions that may affect force application. For instance, lower forces may be advised for patients with periodontal issues such as bone loss, since, for example, the amount of bone surrounding tooth roots may have deteriorated. Bone loss may alter the center of resistance (e.g., the center of resistance may be moved upward), which may necessitate revision of the applied force system (e.g., forces and/or moment) and/or additional counter-tipping forces. In some embodiments, when such a case is encountered, the palatal expander geometry may be adjusted so that it necessarily contacts the gingiva along the lingual side (as previously described) and pushes outward against the alveolar bone so as to reduce expansion forces directly applied on the teeth.

Other relevant parameters that may be considered when designing the palatal expander geometry include any of the following: ensuring proper fit and retention of the palatal expander on the patient's teeth; ensuring that the palatal expander applies sufficient forces to effectively expand the mid-palatal suture while avoiding excessive forces that may lead to discomfort and/or injury; ensuring that the forces applied by the palatal expander are applied with the correct magnitude and direction and at the correct location, given the predicted changes in the palatal geometry (e.g., upward shifting of the expansion axis); and/or applying sufficient compensating forces to counteract undesired tipping of teeth.

The method 1500 can further include outputting instructions for fabrication of the palatal expander with the determined geometry 1508. The instructions can be any digital data set suitable for controlling the operation of a fabrication system to be used to produce the palatal expander. In some embodiments, for example, the fabrication system is an additive manufacturing system, such as an additive manufacturing system including an energy source (e.g., a laser or light engine) configured to apply energy to a precursor material (e.g., a polymeric powder or resin) to form the palatal expander in a layer-by-layer manner. In such embodiments, the instructions can be configured to control the energy produced by the energy source to form the palatal expander from a plurality of layers of the precursor material according to the geometry specified in the digital representation of the palatal expander.

Although the method 1500 is described above with respect to a single palatal expander, in other embodiments, the method 1500 can be used to concurrently or sequentially design a plurality of palatal expanders. In some embodiments, for example, the method 1500 can be used to fabricate an entire series of palatal expanders, based on the initial geometry of the patient's palate before starting palatal expansion treatment. Alternatively, the method 1500 can be used to fabricate smaller batches of palatal expanders before and/or during palatal expansion treatment, e.g., a first batch can be fabricated based on the pre-treatment geometry of the palate, a second batch can be fabricated based on the mid-treatment geometry of the palate, etc. This approach can improve prediction accuracy, e.g., particularly if the changes in the palatal geometry are expected to be nonlinear (e.g., the types and extent of movement may differ before and after suture opening).

Optionally, the palatal expansion treatment plans described herein may also include systems for continuous monitoring of the patient response. For instance, photographs of the patient obtained during treatment may be used to evaluate the palatal geometry and may be obtained using a mobile computing device (e.g., a smartphone) or another suitable device with a camera. As another example, data from sensors embedded in the palatal expander can provide ongoing data on expansion forces, force distribution, and/or tissue responses. These and other types of mid-treatment data can provide important information for accommodating the natural variability in patient responses and for enhancing the personalized treatment approach. Such data can be used to train and/or refine machine learning models, allowing for the fine-tuning of force application and/or palatal expander design in subsequent treatment stages. Such data can also be used to adjust the parameters, constraints, material properties, etc., used in the physics-based models described herein.

In some embodiments, the palatal expansion treatment plan may be revised mid-treatment based on real-time feedback from patient monitoring. For example, if patient photographs show white indentation marks on the soft tissue or unexpected interstitial fluid, the palatal expander device designs for subsequent treatment stages can be revised to further increase the clearance gap with the soft tissue. Bayesian or fine-tuning methods can be employed to continuously update the predictions based on new data, thus enabling adaptive treatment plans that respond to each patient's unique physiological changes.

### II. Dental Appliances and Associated Methods

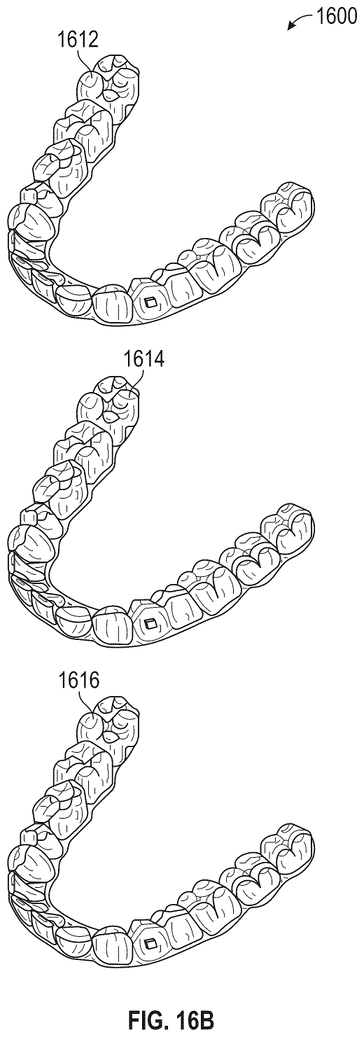

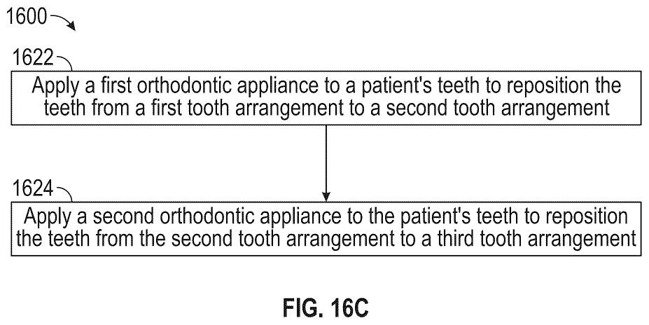

FIG. 16A illustrates a representative example of a tooth repositioning appliance 1600 configured in accordance with embodiments of the present technology. The appliance 1600 can be used in combination with any of the systems, methods, and devices described herein. The appliance 1600 (also referred to herein as an “aligner”) can be worn by a patient in order to achieve an incremental repositioning of individual teeth 1602 in the jaw. The appliance 1600 can include a shell (e.g., a continuous polymeric shell or a segmented shell) having teeth-receiving cavities that receive and resiliently reposition the teeth. The appliance 1600 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1600 can fit over all teeth present in an upper or lower jaw, or less than all of the teeth. The appliance 1600 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1600 can be a generic appliance configured to receive the teeth, but not necessarily shaped to match the topography of the patient's teeth. In some cases, only certain teeth received by the appliance 1600 are repositioned by the appliance 1600 while other teeth can provide a base or mounting region for holding the appliance 1600 in place as it applies force against the tooth or teeth targeted for repositioning. In some cases, some, most, or even all of the teeth can be repositioned at some point during treatment. Teeth that are moved can also serve as a base or mounting region for holding the appliance as it is worn by the patient. In preferred embodiments, no wires or other means are provided for holding the appliance 1600 in place over the teeth. In some cases, however, it may be desirable or necessary to provide individual attachments 1604 or other auxiliaries (e.g., buttons) on teeth 1602 with corresponding receptacles 1606 or apertures in the appliance 1600 so that the appliance 1600 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 16B illustrates a tooth repositioning system 1610 including a plurality of appliances 1612, 1614, 1616, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1610 can include a first appliance 1612 corresponding to an initial tooth arrangement, one or more intermediate appliances 1614 corresponding to one or more intermediate arrangements, and a final appliance 1616 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 16C illustrates a method 1620 of orthodontic treatment using a plurality of appliances, in accordance with embodiments of the present technology. The method 1620 can be practiced using any of the appliances or appliance sets described herein. In block 1622, a first orthodontic appliance is applied to a patient's teeth in order to reposition the teeth from a first tooth arrangement to a second tooth arrangement. In block 1624, a second orthodontic appliance is applied to the patient's teeth in order to reposition the teeth from the second tooth arrangement to a third tooth arrangement. The method 1620 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

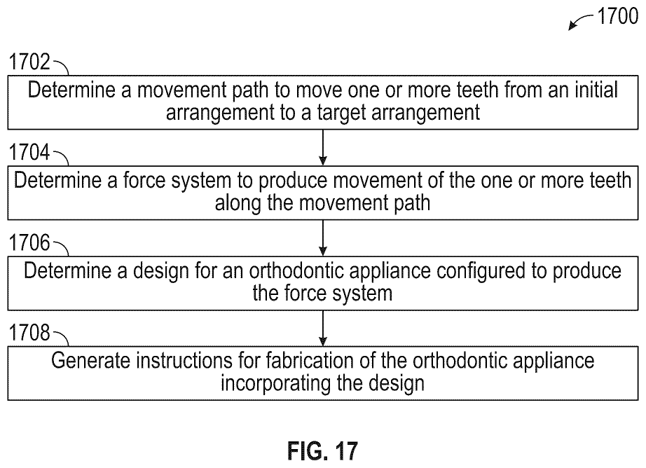

FIG. 17 illustrates a method 1700 for designing an orthodontic appliance, in accordance with embodiments of the present technology. The method 1700 can be applied to any embodiment of the orthodontic appliances described herein. Some or all of the steps of the method 1700 can be performed by any suitable data processing system or device, e.g., one or more processors configured with suitable instructions.

In block 1702, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1704, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1704 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1706, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systemes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1708, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1700 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1700 may be performed with any suitable fabrication system or device, such as the embodiments described herein. Some of the steps may be optional, e.g., the process of block 1704 can be omitted, such that the orthodontic appliance is designed based on the desired tooth movements and/or determined tooth movement path, rather than based on a force system. Moreover, the order of the steps can be varied as desired.

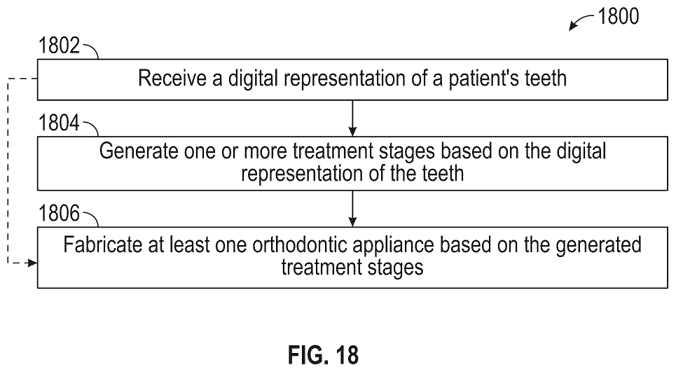

FIG. 18 illustrates a method 1800 for digitally planning an orthodontic treatment and/or design or fabrication of an appliance, in accordance with embodiments. The method 1800 can be applied to any of the treatment procedures described herein and can be performed by any suitable data processing system.

In block 1802, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1804, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1806, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 18, design and/or fabrication of an orthodontic appliance, and perhaps a particular orthodontic treatment, may include use of a representation of the patient's teeth (e.g., including receiving a digital representation of the patient's teeth (block 1802)), followed by design and/or fabrication of an orthodontic appliance based on a representation of the patient's teeth in the arrangement represented by the received representation.

The embodiments herein can be used in combination with aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

As described above, the embodiments herein can be used in combination with dental auxiliary positioners, e.g., devices used to position prefabricated attachments and/or other auxiliaries on a person's teeth in accordance with one or more aspects of a treatment plan. Examples of dental auxiliary positioner (also known as “attachment placement devices,” “attachment placement templates,” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The embodiments herein can be used in combination with incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### Examples

The following examples are included to further describe some aspects of the present technology, and should not be used to limit the scope of the technology.

Example 1. A computer-implemented method for predicting palatal geometry, the computer-implemented method comprising, by one or more processors:
accessing a first digital representation comprising an initial geometry of a patient's palate;
inputting the first digital representation into a trained machine learning model, wherein the machine learning model is trained to predict changes in palatal geometry during palatal expansion treatment, and wherein the training is based on pre-treatment data and post-treatment data from a plurality of patients that have undergone palatal expansion treatment; and
outputting a second digital representation comprising a predicted geometry of the patient's palate at a future treatment stage of a palatal expansion treatment plan, based on output of the machine learning model.

Example 2. The computer-implemented method of Example 1, wherein the predicted geometry comprises a predicted geometry of soft tissue of the patient's palate.

Example 3. The computer-implemented method of Example 1 or 2, wherein the first digital representation comprises or is based on one or more of the following: scan data, photographic data, video data, magnetic resonance imaging data, or radiographic data.

Example 4. The computer-implemented method of Example 3, wherein the first digital representation comprises or is based on the radiographic data, and wherein the radiographic data comprises cone beam computed tomography (CBCT) data.

Example 5. The computer-implemented method of any one of Examples 1 to 4, wherein the first digital representation comprises a height map, a point cloud, a mesh, a grid, a triplane, or an image.

Example 6. The computer-implemented method of any one of Examples 1 to 5, wherein the machine learning model comprises one or more of the following: a linear regression model, a multi-layer perceptron, a convolutional neural network, a recurrent neural network, a graph neural network, or a transformer.

Example 7. The computer-implemented method of any one of Examples 1 to 6, wherein the initial geometry is a geometry of the patient's palate before the patient has started the palatal expansion treatment plan.

Example 8. The computer-implemented method of any one of Examples 1 to 7, wherein the initial geometry is a geometry of the patient's palate after the patient has started the palatal expansion treatment plan.

Example 9. The computer-implemented method of any one of Examples 1 to 8, wherein the future treatment stage is an intermediate treatment stage, a final treatment stage, or a post-treatment stage.

Example 10. The computer-implemented method of any one of Examples 1 to 9, wherein the palatal expansion treatment plan comprises applying a series of palatal expanders to the patient's teeth to adjust the patient's palate from the initial geometry toward a target geometry.

Example 11. The computer-implemented method of any one of Examples 1 to 10, further comprising determining a geometry of a palatal expander configured to implement a treatment stage of the palatal expansion treatment plan, based on the predicted geometry of the patient's palate.

Example 12. The computer-implemented method of Example 11, wherein the determined geometry of the palatal expander is configured to maintain a clearance gap between the palatal expander and soft tissue of the patient's palate.

Example 13. The computer-implemented method of Example 11 or 12, wherein the palatal expander comprises:
a first tooth engagement portion configured to receive one or more first teeth of the patient;
a second tooth engagement portion configured to receive one or more second teeth of the patient; and
a palatal portion between the first and second tooth engagement portions.

Example 14. The computer-implemented method of any one of Examples 11 to 13, wherein the palatal expander is configured to apply force to expand the patient's palate without contacting the patient's gingiva.

Example 15. The computer-implemented method of any one of Examples 11 to 13, wherein the palatal expander is configured to apply force to expand the patient's palate while contacting the patient's gingiva.

Example 16. The computer-implemented method of any one of Examples 11 to 15, wherein the palatal expander is configured to apply an expansion force within a range from 9 N to 20 N.

Example 17. The computer-implemented method of any one of Examples 11 to 16, further comprising generating instructions for fabrication of the palatal expander with the determined geometry.

Example 18. A computer-implemented method for predicting palatal geometry, the computer-implemented method comprising, by one or more processors:
receiving, at a first client device, a first digital representation comprising an initial geometry of a patient's palate;
transmitting, from the first client device to a server device, the first digital representation; and
receiving, from the server device, a second digital representation comprising a predicted geometry of the patient's palate at a future treatment stage of a palatal expansion treatment plan, wherein the second digital representation is based on an output generated by a machine learning model trained to predict changes in palatal geometry during palatal expansion treatment, wherein the training is based on pre-treatment data and post-treatment data from a plurality of patients that have undergone palatal expansion treatment, and wherein the output is based on the first digital representation.

Example 19. The computer-implemented method of Example 18, further comprising capturing the first digital representation using an intraoral scanner or a camera device.

Example 20. The computer-implemented method of Example 18 or 19, further comprising displaying, on an output device, a visual representation corresponding to the second digital representation.

Example 21. A computer-implemented method for predicting an anatomy of a patient's palate, the computer-implemented method comprising, by one or more processors:
accessing a first digital representation comprising an initial geometry of soft tissue corresponding to a patient's palate;
determining an initial geometry of hard tissue of the patient's palate based on the first digital representation;
predicting a change in the hard tissue during a palatal expansion treatment;
using the predicted change in the hard tissue to predict a change in the soft tissue during the palatal expansion treatment; and
outputting a second digital representation comprising a predicted geometry of the patient's palate at a future treatment stage of a palatal expansion treatment plan, based on the predicted change in the soft issue.

Example 22. The computer-implemented method of Example 21, wherein the change in the soft tissue comprises deformation of the soft tissue caused by the predicted change of the hard tissue.

Example 23. The computer-implemented method of Example 21 or 22, wherein the change in the soft tissue is predicted using a simulation.

Example 24. The computer-implemented method of any one of Examples 21 to 23, wherein the change in the soft tissue is predicted using a finite element method (FEM) model of the soft tissue.

Example 25. The computer-implemented method of Example 24, wherein the predicted change in the hard tissue is used to determine one or more of a boundary condition or a geometric constraint for the FEM model of the soft tissue.

Example 26. The computer-implemented method of any one of Examples 21 to 25, wherein the first digital representation comprises the initial geometry of the hard tissue.

Example 27. The computer-implemented method of any one of Examples 21 to 26, wherein the predicted change in the soft tissue is based on estimated material properties of the soft tissue.

Example 28. The computer-implemented method of any one of Examples 21 to 27, wherein the predicted change in the hard tissue comprises one or more of the following: translation of a maxillary region, rotation of a maxillary region about an expansion axis, or a change in a location of the expansion axis.

Example 28A. The computer-implemented method of Example 28, wherein the change in the location of the expansion axis comprises a change in one or more of a position or an orientation of the expansion axis.

Example 29. The computer-implemented method of any one of Examples 21 to 28A, wherein the initial geometry is a geometry of the patient's palate before the patient has started the palatal expansion treatment plan.

Example 30. The computer-implemented method of any one of Examples 21 to 28A, wherein the initial geometry is a geometry of the patient's palate after the patient has started the palatal expansion treatment plan.

Example 31. The computer-implemented method of any one of Examples 21 to 30, wherein the future treatment stage is an intermediate treatment stage, a final treatment stage, or a post-treatment stage.

Example 32. The computer-implemented method of any one of Examples 21 to 31, wherein the palatal expansion treatment plan comprises applying a series of palatal expanders to the patient's teeth to adjust the patient's palate from the initial geometry toward a target geometry.

Example 33. The computer-implemented method of any one of Examples 21 to 32, further comprising determining a geometry of a palatal expander configured to implement a treatment stage of the palatal expansion treatment plan, based on the predicted geometry of the patient's palate.

Example 34. The computer-implemented method of Example 33, wherein the determined geometry of the palatal expander is configured to maintain a clearance gap between the palatal expander and soft tissue of the patient's palate.

Example 35. The computer-implemented method of Example 33 or 34, wherein the palatal expander comprises:
a first tooth engagement portion configured to receive one or more first teeth of the patient;
a second tooth engagement portion configured to receive one or more second teeth of the patient; and
a palatal portion between the first and second tooth engagement portions.

Example 36. The computer-implemented method of any one of Examples 33 to 35, wherein the palatal expander is configured to apply force to expand the patient's palate without contacting the patient's gingiva.

Example 37. The computer-implemented method of any one of Examples 33 to 35, wherein the palatal expander is configured to apply force to expand the patient's palate while contacting the patient's gingiva.

Example 38. The computer-implemented method of any one of Examples 33 to 37, wherein the palatal expander is configured to apply an expansion force within a range from 9 N to 20 N.

Example 39. The computer-implemented method of any one of Examples 33 to 38, further comprising generating instructions for fabrication of the palatal expander with the determined geometry.

Example 40. A computer-implemented method for predicting palatal geometry, the computer-implemented method comprising, by one or more processors:
receiving, at a first client device, a first digital representation comprising an initial geometry of soft tissue corresponding to a patient's palate;
transmitting, from the first client device to a server device, the first digital representation; and
receiving, from the server device, a second digital representation comprising a predicted geometry of the patient's palate at a future treatment stage of a palatal expansion treatment plan, wherein the second digital representation is based on a predicted change in the soft tissue, wherein the predicted change in the soft tissue is based on a predicted change in hard tissue during a palatal expansion treatment, and wherein an initial geometry of the hard tissue is determined based on the first digital representation.

Example 41. The computer-implemented method of Example 40, further comprising capturing the first digital representation using an intraoral scanner or a camera device.

Example 42. The computer-implemented method of Example 40 or 41, further comprising displaying, on an output device, a visual representation corresponding to the second digital representation.

Example 43. A computer-implemented method for predicting an anatomy of a patient's palate, the computer-implemented method comprising, by one or more processors:
accessing a first digital representation comprising an initial geometry of a patient's palate;
determining, based on the first digital representation:
   an expansion axis, and
   a digital component corresponding to a maxillary region of the patient's palate, the digital component having a first portion proximate to the expansion axis and a second portion spaced apart from the expansion axis, wherein the second portion has greater lateral deformability than the first portion;
predicting a response of the patient's palate to a palatal expansion treatment by rotating the digital component around the expansion axis and deforming the digital component laterally outward; and
outputting a second digital representation comprising a predicted geometry of the patient's palate at a future treatment stage of a palatal expansion treatment plan, based on the predicted response.

Example 44. The computer-implemented method of Example 43, wherein the digital component comprises a series of vector objects, and wherein each vector object is connected to an adjacent vector object via a joint.

Example 45. The computer-implemented method of Example 44, wherein predicting the response comprises determining a movement of each vector object via an inverse kinematics process.

Example 46. The computer-implemented method of any one of Examples 43 to 45, wherein the digital component is a beam having a fixed end and a free end, and wherein the first portion comprises the fixed end and the second portion comprises the free end.

Example 47. The computer-implemented method of any one of Examples 43 to 46, wherein predicting the response comprises determining an amount of bending of the beam.

Example 48. The computer-implemented method of any one of Examples 43 to 47, wherein predicting the response further comprises predicting a change in a location of the expansion axis.

Example 49. The computer-implemented method of any one of Examples 43 to 48, wherein the initial geometry is a geometry of the patient's palate before the patient has started the palatal expansion treatment plan.

Example 50. The computer-implemented method of any one of Examples 43 to 48, wherein the initial geometry is a geometry of the patient's palate after the patient has started the palatal expansion treatment plan.

Example 51. The computer-implemented method of any one of Examples 43 to 50, wherein the predicted geometry comprises a predicted geometry of soft tissue of the patient's palate.

Example 52. The computer-implemented method of any one of Examples 43 to 51, wherein the future treatment stage is an intermediate treatment stage, a final treatment stage, or a post-treatment stage.

Example 53. The computer-implemented method of any one of Examples 43 to 52, wherein the palatal expansion treatment plan comprises applying a series of palatal expanders to the patient's teeth to adjust the patient's palate from the initial geometry toward a target geometry.

Example 54. The computer-implemented method of any one of Examples 43 to 53, further comprising determining a geometry of a palatal expander configured to implement a treatment stage of the palatal expansion treatment plan, based on the predicted geometry of the patient's palate.

Example 55. The computer-implemented method of Example 54, wherein the determined geometry of the palatal expander is configured to maintain a clearance gap between the palatal expander and soft tissue of the patient's palate.

Example 56. The computer-implemented method of Example 54 or 55, wherein the palatal expander comprises:
a first tooth engagement portion configured to receive one or more first teeth of the patient;
a second tooth engagement portion configured to receive one or more second teeth of the patient; and
a palatal portion between the first and second tooth engagement portions.

Example 57. The computer-implemented method of any one of Examples 54 to 56, wherein the palatal expander is configured to apply force to expand the patient's palate without contacting the patient's gingiva.

Example 58. The computer-implemented method of any one of Examples 54 to 56, wherein the palatal expander is configured to apply force to expand the patient's palate while contacting the patient's gingiva.

Example 59. The computer-implemented method of any one of Examples 54 to 58, wherein the palatal expander is configured to apply an expansion force within a range from 9 N to 20 N.

Example 60. The computer-implemented method of any one of Examples 54 to 59, further comprising generating instructions for fabrication of the palatal expander with the determined geometry.

Example 61. A computer-implemented method for predicting palatal geometry, the computer-implemented method comprising, by one or more processors:
receiving, at a first client device, a first digital representation comprising an initial geometry of a patient's palate;
transmitting, from the first client device to a server device, the first digital representation; and
receiving, from the server device, a second digital representation comprising a predicted geometry of the patient's palate a future treatment stage of a palatal expansion treatment plan, wherein:
   the second digital representation is based on a predicted response of the patient's palate to a palatal expansion treatment by rotating a digital component corresponding to a maxillary region of the patient's palate around an expansion axis and deforming the digital component laterally outward,
   the digital component has a first portion proximate to the expansion axis and a second portion shaped apart from the expansion axis, the second portion having greater lateral deformability than the first portion, and
   the expansion axis and the digital component are determined based on the first digital representation.

Example 62. The computer-implemented method of Example 61, further comprising capturing the first digital representation using an intraoral scanner or a camera device.

Example 63. The computer-implemented method of Example 61 or 62, further comprising displaying, on an output device, a visual representation corresponding to the second digital representation.

Example 64. A computer-implemented method for predicting an anatomy of a patient's palate, the computer-implemented method comprising, by one or more processors:
accessing a first digital representation comprising an initial geometry of a patient's palate;
determining an expansion axis based on the first digital representation;
predicting a change in a location of the expansion axis during a palatal expansion treatment;
determining a predicted geometry of the patient's palate at a future treatment stage of a palatal expansion treatment plan, based on the predicted change in the location of the expansion axis; and
outputting a second digital representation comprising the predicted geometry.

Example 65. The computer-implemented method of Example 64, wherein the predicted change in location comprises a vertical translation of the expansion axis.

Example 66. The computer-implemented method of Example 64 or 65, wherein the predicted change in location is based on one or more of the following: a machine learning model, a physics-based simulation, or data from other patients that have undergone palatal expansion treatment.

Example 67. The computer-implemented method of any one of Examples 64 to 66, wherein the first digital representation comprises or is based on one or more of the following: scan data, photographic data, video data, magnetic resonance imaging data, or radiographic data.

Example 68. The computer-implemented method of Example 67, wherein the first digital representation comprises or is based on the radiographic data, and wherein the radiographic data comprises cone beam computed tomography (CBCT) data.

Example 69. The computer-implemented method of any one of Examples 64 to 68, wherein determining the predicted geometry comprises modeling a rotation of a maxillary region of the patient's palate around the expansion axis.

Example 70. The computer-implemented method of any one of Examples 64 to 69, wherein determining the predicted geometry comprises:
determining a first predicted geometry of the patient's palate for a first treatment stage of the palatal expansion treatment plan, based on the expansion axis being at a first location; and
determining a second predicted geometry of the patient's palate for a second treatment stage of the palatal expansion treatment plan, based on the expansion axis being at a second location different from the first location.

Example 71. The computer-implemented method of any one of Examples 64 to 70, wherein the predicted geometry comprises a predicted geometry of soft tissue of the patient's palate.

Example 72. The computer-implemented method of any one of Examples 64 to 71, wherein the future treatment stage is an intermediate treatment stage, a final treatment stage, or a post-treatment stage.

Example 73. The computer-implemented method of any one of Examples 64 to 72, wherein the palatal expansion treatment plan comprises applying a series of palatal expanders to the patient's teeth to adjust the patient's palate from the initial geometry toward a target geometry.

Example 74. The computer-implemented method of any one of Examples 64 to 73, further comprising determining a geometry of a palatal expander configured to implement a treatment stage of the palatal expansion treatment plan, based on the predicted geometry of the patient's palate.

Example 75. The computer-implemented method of Example 74, wherein the determined geometry of the palatal expander is configured to maintain a clearance gap between the palatal expander and soft tissue of the patient's palate.

Example 76. The computer-implemented method of Example 74 or 75, wherein the palatal expander comprises:
a first tooth engagement portion configured to receive one or more first teeth of the patient;
a second tooth engagement portion configured to receive one or more second teeth of the patient; and
a palatal portion between the first and second tooth engagement portions.

Example 77. The computer-implemented method of any one of Examples 74 to 76, wherein the palatal expander is configured to apply force to expand the patient's palate without contacting the patient's gingiva.

Example 78. The computer-implemented method of any one of Examples 74 to 76, wherein the palatal expander is configured to apply force to expand the patient's palate while contacting the patient's gingiva.

Example 79. The computer-implemented method of any one of Examples 74 to 78, wherein the palatal expander is configured to apply an expansion force within a range from 9 N to 20 N.

Example 80. The computer-implemented method of any one of Examples 74 to 79, further comprising generating instructions for fabrication of the palatal expander with the determined geometry.

Example 81. A computer-implemented method for predicting palatal geometry, the computer-implemented method comprising, by one or more processors:
receiving, at a first client device, a first digital representation comprising an initial geometry of a patient's palate;
transmitting, from the first client device to a server device, the first digital representation; and
receiving, from the server device, a second digital representation comprising a predicted geometry of the patient's palate at a future treatment stage of a palatal expansion treatment plan, wherein the predicted geometry is determined based on a predicted change in a location of an expansion axis, and wherein the expansion axis is determined based on the first digital representation.

Example 82. The computer-implemented method of Example 81, further comprising capturing the first digital representation using an intraoral scanner or a camera device.

Example 83. The computer-implemented method of Example 81 or 82, further comprising displaying, on an output device, a visual representation corresponding to the second digital representation.

Example 84. A computer-implemented method for designing a dental appliance for expanding a patient's palate, the computer-implemented method comprising, by one or more processors:
accessing a digital representation comprising an initial geometry of a patient's palate;
determining a predicted geometry of soft tissue of the patient's palate at a future treatment stage of a palatal expansion treatment plan, based on the digital representation;
determining a geometry of a palatal expander configured to implement the future treatment stage of the palatal expansion treatment plan, based on the predicted geometry of the soft tissue of the patient's palate; and
outputting instructions for fabrication of the palatal expander with the determined geometry.

Example 85. The computer-implemented method of Example 84, wherein the determined geometry of the palatal expander is configured to maintain a clearance gap between the palatal expander and the soft tissue of the patient's palate.

Example 86. The computer-implemented method of Example 84 or 85, wherein the determining the geometry of the palatal expander comprises identifying whether the patient has periodontal bone loss.

Example 87. The computer-implemented method of any one of Examples 84 to 86, wherein determining the predicted geometry of the soft tissue comprises predicting a change in a location of an expansion axis of the patient's palate.

Example 88. The computer-implemented method of any one of Examples 84 to 87, wherein the predicted geometry of the soft tissue is determined using a machine learning model, a physics-based simulation, or a combination thereof.

Example 89. The computer-implemented method of any one of Examples 84 to 88, wherein the digital representation comprises a first component corresponding to hard tissue of the patient's palate and a second component corresponding to the soft tissue.

Example 90. The computer-implemented method of any one of Examples 84 to 89, wherein the digital representation comprises or is based on one or more of the following: scan data, photographic data, video data, magnetic resonance imaging data, or radiographic data.

Example 91. The computer-implemented method of Example 90, wherein the digital representation comprises or is based on the radiographic data, and wherein the radiographic data comprises cone beam computed tomography (CBCT) data.

Example 92. The computer-implemented method of any one of Examples 84 to 91, wherein the palatal expander comprises:
a first tooth engagement portion configured to receive one or more first teeth of the patient;
a second tooth engagement portion configured to receive one or more second teeth of the patient; and
a palatal portion between the first and second tooth engagement portions.

Example 93. The computer-implemented method of any one of Examples 84 to 92, wherein the palatal expander is configured to apply force to expand the patient's palate without contacting the patient's gingiva.

Example 94. The computer-implemented method of any one of Examples 84 to 92, wherein the palatal expander is configured to apply force to expand the patient's palate while contacting the patient's gingiva.

Example 95. The computer-implemented method of any one of Examples 84 to 94, wherein the palatal expander is configured to apply an expansion force within a range from 9 N to 20 N.

Example 96. A system comprising:
one or more processors; and
a memory operably coupled to the one or more processors and storing instructions that, when executed by the one or more processors, cause the system to perform operations comprising the computer-implemented method of any one of Examples 1 to 95.

Example 97. A non-transitory computer-readable storage medium comprising instructions that, when executed by one or more processors of a computing system, cause the computing system to perform operations comprising the computer-implemented method of any one of Examples 1 to 95.

### CONCLUSION

Although many of the embodiments are described above with respect to systems, devices, and methods for palatal expansion, the technology is applicable to other applications and/or other approaches, such as other types of dental and/or orthodontic treatments. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-19.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A system for predicting an anatomy of a patient's palate, the system comprising:
one or more processors; and
a memory operably coupled to the one or more processors and storing instructions that, when executed by the one or more processors, cause the system to perform operations comprising:
accessing a first digital representation comprising an initial geometry of soft tissue corresponding to a patient's palate;
determining an initial geometry of hard tissue of the patient's palate based on the first digital representation;
predicting a change in the hard tissue during a palatal expansion treatment;
using the predicted change in the hard tissue to predict a change in the soft tissue during the palatal expansion treatment; and
outputting a second digital representation comprising a predicted geometry of the patient's palate at a future treatment stage of a palatal expansion treatment plan, based on the predicted change in the soft issue.

2. The system of claim 1, wherein the change in the soft tissue comprises deformation of the soft tissue caused by the predicted change of the hard tissue.

3. The system of claim 1, wherein the change in the soft tissue is predicted using a finite element method (FEM) model of the soft tissue, and wherein the predicted change in the hard tissue is used to determine one or more of a boundary condition or a geometric constraint for the FEM model of the soft tissue.

4. The system of claim 1, wherein the first digital representation comprises the initial geometry of the hard tissue.

5. The system of claim 1, wherein the predicted change in the soft tissue is based on estimated material properties of the soft tissue.

6. The system of claim 1, wherein the predicted change in the hard tissue comprises one or more of the following: translation of a maxillary region, rotation of a maxillary region about an expansion axis, or a change in a location of the expansion axis.

7. The system of claim 6, wherein the change in the location of the expansion axis comprises a change in one or more of a position or an orientation of the expansion axis.

8. The system of claim 1, wherein the initial geometry is a geometry of the patient's palate before or after the patient has started the palatal expansion treatment plan.

9. The system of claim 1, wherein the future treatment stage is an intermediate treatment stage, a final treatment stage, or a post-treatment stage.

10. The system of claim 1, wherein the operations further comprise determining a geometry of a palatal expander configured to implement a treatment stage of the palatal expansion treatment plan, based on the predicted geometry of the patient's palate.

11. A system for predicting palatal geometry, the system comprising:
one or more processors; and
a memory operably coupled to the one or more processors and storing instructions that, when executed by the one or more processors, cause the system to perform operations comprising:
receiving, at a first client device, a first digital representation comprising an initial geometry of soft tissue corresponding to a patient's palate;
transmitting, from the first client device to a server device, the first digital representation; and
receiving, from the server device, a second digital representation comprising a predicted geometry of the patient's palate at a future treatment stage of a palatal expansion treatment plan, wherein the second digital representation is based on a predicted change in the soft tissue, wherein the predicted change in the soft tissue is based on a predicted change in hard tissue during a palatal expansion treatment, and wherein an initial geometry of the hard tissue is determined based on the first digital representation.

12. The system of claim 11, further comprising an intraoral scanner or a camera device configured to capture the first digital representation.

13. The system of claim 11, wherein the operations further comprise displaying, on an output device, a visual representation corresponding to the second digital representation.

14. A system for designing a dental appliance for expanding a patient's palate, the system comprising:
one or more processors; and
a memory operably coupled to the one or more processors and storing instructions that, when executed by the one or more processors, cause the system to perform operations comprising:
accessing a digital representation comprising an initial geometry of a patient's palate;
determining a predicted geometry of soft tissue of the patient's palate at a future treatment stage of a palatal expansion treatment plan, based on the digital representation;
determining a geometry of a palatal expander configured to implement the future treatment stage of the palatal expansion treatment plan, based on the predicted geometry of the soft tissue of the patient's palate; and
outputting instructions for fabrication of the palatal expander with the determined geometry.

15. The system of claim 14, wherein the determined geometry of the palatal expander is configured to maintain a clearance gap between the palatal expander and the soft tissue of the patient's palate.

16. The system of claim 14, wherein determining the predicted geometry of the soft tissue comprises predicting a change in a location of an expansion axis of the patient's palate.

17. The system of claim 14, wherein the predicted geometry of the soft tissue is determined using a machine learning model, a physics-based simulation, or a combination thereof.

18. The system of claim 14, wherein the digital representation comprises a first component corresponding to hard tissue of the patient's palate and a second component corresponding to the soft tissue.

19. The system of claim 14, wherein the digital representation comprises or is based on one or more of the following: scan data, photographic data, video data, magnetic resonance imaging data, or radiographic data.

20. The system of claim 14, wherein the palatal expander comprises:
a first tooth engagement portion configured to receive one or more first teeth of the patient;
a second tooth engagement portion configured to receive one or more second teeth of the patient; and
a palatal portion between the first and second tooth engagement portions.
